(19) United States
(12) Patent Application Publication
(10) Pub. No.: US 2024/0163387 A1
(43) Pub. Date: May 16, 2024

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Naohiro SAWATA, Kanagawa (JP)

(73) Assignee: FUJIFILM Business Innovation Corp., Tokyo (JP)

(21) Appl. No.: 18/317,133

(22) Filed: May 15, 2023

(30) Foreign Application Priority Data
Nov. 11, 2022 (JP) 2022-181391

(51) Int. Cl. H04N 1/00

(52) U.S. Cl. CPC H04N 1/00954; H04N 1/00915

(57) ABSTRACT

An information processing apparatus includes a processor configured to: associate a production process for producing a product with an equipment grouping that includes multiple pieces of equipment capable of executing the production process; and assign, if the production process is associated with the equipment grouping, the production process to an operating schedule of one of the multiple pieces of equipment on the basis of a predetermined condition.

### CROSS-REFERENCE TO RELATED APPLICATIONS

This application is based on and claims priority under 35 USC 119 from Japanese Patent Application No. 2022-181391 filed Nov. 11, 2022.

### BACKGROUND

### (i) Technical Field

The present disclosure relates to an information processing apparatus and a non-transitory computer readable medium.

### (ii) Related Art

Japanese Patent No. 6338077 discloses a facility planning assistance system provided with: a demand information acquisition unit that acquires demand information, that is, individual product information indicating demand for products produced through production processes at one or more production sites, the demand information including the types of products and customer requests to the production sites; a production group condition acquisition unit that acquires a production group condition indicating a condition by which to classify the demand information into groups for each of the production processes according to the types of products and the customer requests to the production sites; a process grouping implementation unit that classifies the demand information for each of the production processes on the basis of the production group condition; a production route aggregation unit that determines production routes for the classified demand information by allocating production lines according to the production site for each of the production process included in the demand information, and aggregates the demand information for each production route; and a production allocation unit that, for each of the aggregated production routes, allocates production capacity based on the demand information to each production line forming that production route.

### SUMMARY

It is conceivable to have an information processing apparatus including a processor, in which the processor is capable of associating a production process for producing a product with only a single piece of equipment capable of executing the production process, such that if the production process is associated with the single piece of equipment, the production process is assigned to an operating schedule of the piece of equipment on the basis of a predetermined condition.

In this information processing apparatus, if the operating schedule of the single piece of equipment is full, assigning the production process may be difficult in some cases.

Aspects of non-limiting embodiments of the present disclosure relate to avoiding a situation in which a production process for producing a product cannot be assigned to the operating schedule of a piece of equipment compared to the case in which the production process may be associated with only a single piece of equipment capable of executing the production process.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: associate a production process for producing a product with an equipment grouping that includes multiple pieces of equipment capable of executing the production process; and assign, if the production process is associated with the equipment grouping, the production process to an operating schedule of one of the multiple pieces of equipment on the basis of a predetermined condition.

### BRIEF DESCRIPTION OF THE DRAWINGS

An exemplary embodiment of the present disclosure will be described in detail based on the following figures, wherein:

FIG. 1 is a schematic diagram illustrating an example of a production system according to an exemplary embodiment;

FIG. 2 is a schematic diagram illustrating an example of an assignment screen according to the exemplary embodiment;

FIG. 3 is a schematic diagram illustrating a state in which settable starting dates and times are displayed on the assignment screen illustrated in FIG. 2;

FIG. 4 is a schematic diagram illustrating an example of a grace period setting screen according to the exemplary embodiment;

FIG. 5 is a schematic diagram illustrating an example of an equipment group setting screen according to the exemplary embodiment;

FIG. 6 is a schematic diagram illustrating an example of an equipment setting screen according to the exemplary embodiment;

FIG. 7 is a block diagram illustrating an example of a functional configuration of a production management system according to the exemplary embodiment;

FIG. 8 is a flowchart illustrating an example of the flow of assignment processing executed by the production management system according to the exemplary embodiment;

FIGS. 9A and 9B are flowcharts illustrating an example of the flow of process assignment processing executed by the production management system according to the exemplary embodiment;

FIG. 10 is a schematic diagram illustrating an assignment screen according to a first specific example;

FIG. 11 is a schematic diagram illustrating an assignment screen according to the first specific example;

FIG. 12 is a schematic diagram illustrating an assignment screen according to the first specific example;

FIG. 13 is a schematic diagram illustrating an assignment screen according to a second specific example;

FIG. 14 is a schematic diagram illustrating an assignment screen according to the second specific example;

FIG. 15 is a schematic diagram illustrating an assignment screen according to a third specific example;

FIG. 16 is a schematic diagram illustrating an assignment screen according to a fourth specific example;

FIG. 17 is a schematic diagram illustrating an assignment screen according to the fourth specific example;

FIG. 18 is a schematic diagram illustrating an assignment screen according to the fourth specific example; and

FIGS. 19A and 19B are flowcharts illustrating an exemplary modification of the flow of process assignment processing executed by the production management system according to the exemplary embodiment.

### DETAILED DESCRIPTION

Hereinafter, an exemplary embodiment of the present disclosure will be described in detail on the basis of the drawings.

<Production System 1>

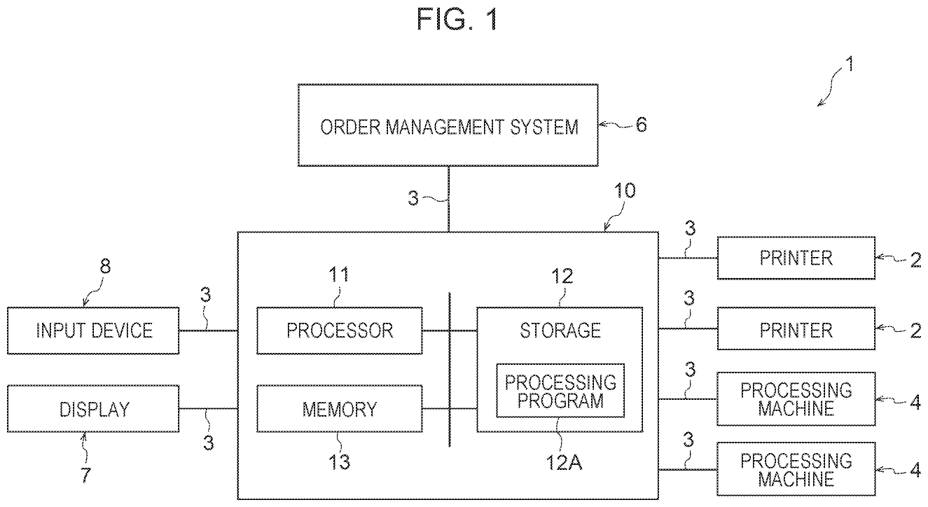

First, a production system 1 according to the exemplary embodiment will be described. FIG. 1 is a schematic diagram illustrating the production system 1 according to the exemplary embodiment.

The production system 1 is a system for producing printed material. In the exemplary embodiment, the production system 1 receives an order for producing printed material, generates a production plan, and equipment produces the printed material in accordance with the production plan.

The printed material to be produced is an example of a product. The printed material may be any of books, booklets, and flyers, for example. Note that the product is not limited to the example of printed material and may be some other industrial product, or may simply be a product produced by equipment.

Specifically, as illustrated in FIG. 1, the manufacturing system 1 is provided with multiple printers 2, multiple processing machines 4, an order management system 6, a display 7, an input device 8, and a production management system 10.

As illustrated in FIG. 1, the components of the production system 1 are connected by communication lines 3. The communication lines 3 use wired lines, wireless channels, or both, for example. Communication lines using wireless channels may use the Internet or an intranet, for example. Hereinafter, each component of the production system 1 will be described.

<Printers 2 and Processing Machines 4>

The printers 2 and processing machines 4 are examples of equipment. The multiple printers 2 are pieces of equipment used to print onto recording media. The multiple processing machines 4 are pieces of equipment used to process the recording media on which printing has been performed. The processing machines 4 may be, among other things, cutting machines for cutting the recording media, binding machines for binding the recording media, and hole-punching machines for punching holes into the recording media.

<Order Management System 6>

The order management system 6 is a system that manages information (hereinafter referred to as production information) related to the production of printed material ordered by a customer. The order management system 6 receives an order for the production of printed material from a customer, and sends production information regarding the printed material to the production management system 10 via the communication line 3.

<Display 7 and Input Device 8>

The display 7 is a component that displays presentation information to be presented to a user. Specifically, in one example, the display 7 is configured as a liquid crystal display (LCD) panel. Note that the display 7 is not limited to an LCD panel and may also be an organic light-emitting diode (OLED) display panel or any other device capable of displaying presentation information to be presented to a user.

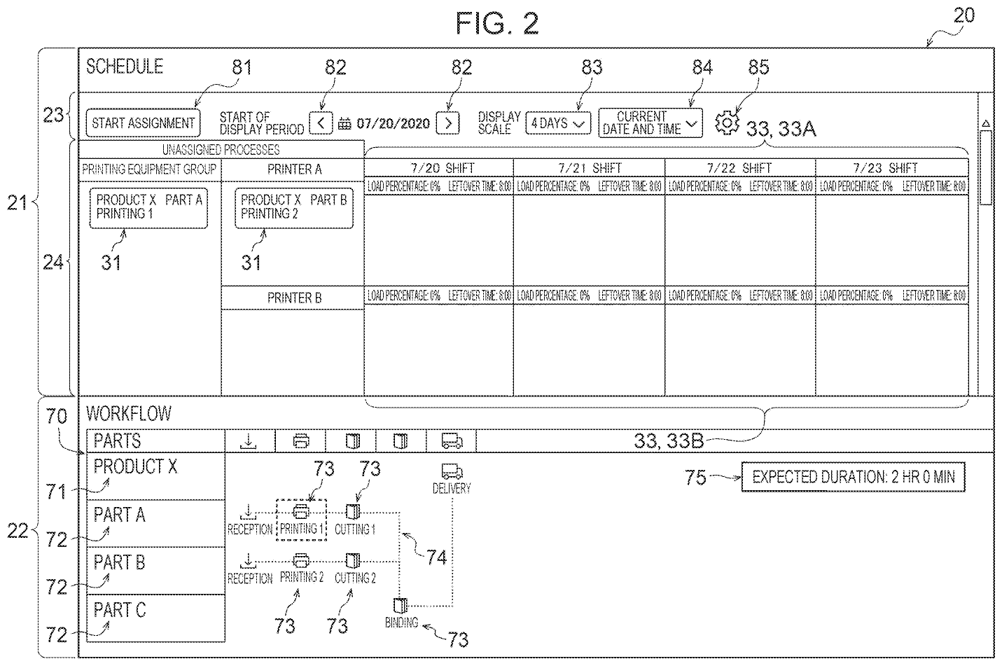

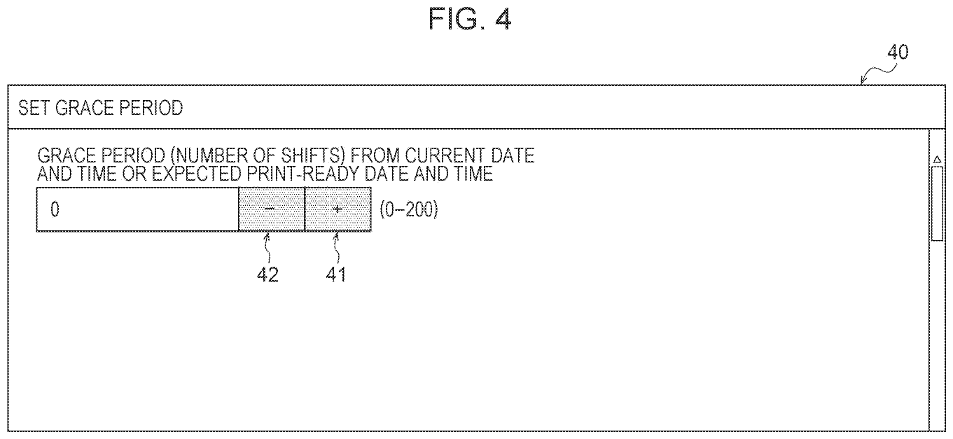

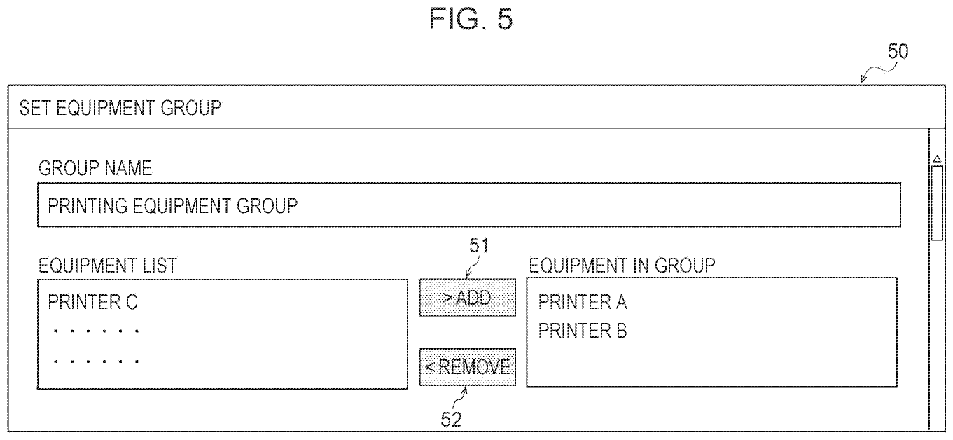

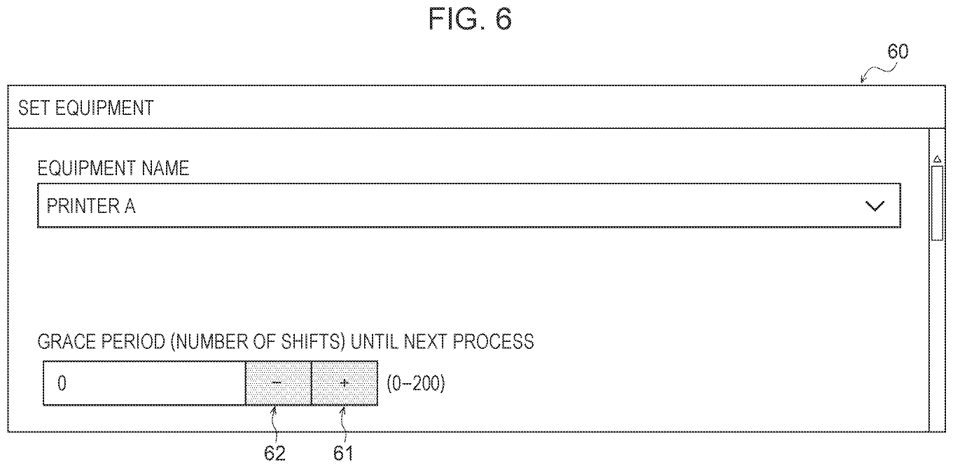

Display screens to be displayed by the display 7 include an assignment screen 20 (see FIG. 2), a grace period setting screen 40 (see FIG. 4), an equipment group setting screen 50 (see FIG. 5), and an equipment setting screen 60 (see FIG. 6). Details of these display screens will be described later.

The input device 8 is a component that accepts instructions inputted by the user. Specifically, in one example, the input device 8 is configured as a pointing device, such as a mouse, and one or more input keys, such as a keyboard.

Note that the input device 8 is not limited to a pointing device and input keys and may also be configured as a touch panel or any other device capable of accepting instructions inputted by the user.

<Assignment Screen 20>

FIG. 2 illustrates an example of the assignment screen 20 displayed on the display 7.

The assignment screen 20 is an input screen capable of accepting user input, namely various instructions including the assignment of production processes to equipment operating schedules, and is also a screen used to indicate various information. The assignment screen 20 includes a schedule display area 21 and a workflow display area 22.

In the workflow display area 22, information (hereinafter referred to as workflow information 70) related to production processes (in other words, a workflow) of a product is displayed. The workflow information 70 is generated on the basis of the production information sent from the order management system 6 to the production management system 10.

In one example, the workflow information 70 includes type information 71 indicating the type of the product to be produced, parts information 72 indicating parts that make up the product, production process information 73 indicating the production processes involved in producing the product, flow information 74 indicating the flow of the production processes, and duration information 75 indicating the durations of the production processes.

Note that in the exemplary embodiment, in one example, a product X is assumed to be a book (one example of printed material), a part A is assumed to be the body of the book, a part B is assumed to be the book cover, and a part C is assumed to be the assemblage combining the part A (specifically, the body) and the part B (specifically, the cover).

Also, in the exemplary embodiment, a printing process 1 and a cutting process 1 are executed with respect to the part A (specifically, the body), a printing process 2 and a cutting process 2 are executed with respect to the part B (specifically, the cover), and a binding process is executed with respect to the part C (specifically, the body and cover) as the production processes. Note that on the assignment screen 20 illustrated in FIG. 2, the word “process” is omitted from display in the notation of the printing processes, the cutting processes, and the binding process.

Also, on the assignment screen 20 illustrated in FIG. 2, the duration information 75 indicates information about the duration of specified production process information 73 from among the production process information 73, for example. On the assignment screen 20 illustrated in FIG. 2, the printing process 1 has been specified, as indicated by the dashed line. The duration is calculated from information about the throughput of the equipment used to execute the relevant production process and production information, for example.

In the schedule display area 21, information related to a production plan (that is, a production schedule) of production processes is displayed. The schedule display area 21 includes a menu area 23 and an assignment area 24.

In the assignment area 24, process information 31 indicating a production process and association destination information indicating an association destination with which the production process is associated are displayed. In the assignment area 24, the process information 31 is displayed as virtual cards.

The association destination may be an equipment group, which includes multiple pieces of equipment, or a single piece of equipment with which a production process is executable. Specifically, in the exemplary embodiment, there is a printing equipment group as an example of an equipment group, and there are printers A and B as an example of single pieces of equipment. Note that an equipment group is an example of an equipment grouping. Equipment such as the printer A and the printer B belongs to a single equipment group, and does not belong to multiple equipment groups.

In the assignment area 24, the process information 31 being displayed inside an equipment group field indicates that the association destination of the production process is that equipment group. Also, in the assignment area 24, the process information 31 being displayed inside the field of either one of the printer A or the printer B indicates that the association destination of the production process is that one.

In the assignment area 24 illustrated in FIG. 2, a case is illustrated in which the printing process 1 is associated with the equipment group and the printing process 2 is associated with the printer A.

Note that in the assignment area 24, the user is able to input an instruction to change the association destination of a production process by using the input device 8 to performing an operation of moving the process information 31, such as by drag and drop, for example.

Furthermore, in the assignment area 24, schedule information 33 indicating an operating schedule of the equipment and information indicating whether production processes are assigned to the operating schedule of the equipment are displayed.

The operating schedule of the equipment is a schedule on which the equipment operates. In the exemplary embodiment, the operating schedule of the equipment is generated in units of operating periods (that is, shifts) operated daily.

In the assignment area 24, schedule information 33A indicating the operating schedule of the printer A from 7/20 to 7/23 and schedule information 33B indicating the operating schedule of the printer B from 7/20 to 7/23 are displayed as the schedule information 33. For example, the 7/20 shift indicates the operating period (for example, from 9:00 to 17:00) on 7/20.

Also, in each shift, information about the leftover time and load percentage of the shift is displayed. The leftover time indicates how long the equipment is operable in the shift, and if a production process is assigned to the shift, the leftover time is displayed by subtracting the duration of the production process. The load percentage indicates the ratio of the operating period (for example, 8 hours) of the equipment that is occupied by the duration of the assigned production process. Consequently, as described later, if an attempt is made to assign a production process to a shift of equipment but the duration of the production process exceeds the leftover time of the shift, it is determined that the shift does not have an opening.

Also, in the assignment area 24, the process information 31 being displayed inside the field of a shift in the schedule information 33 indicates that the process information 31 is assigned to that shift, and the process information 31 being displayed inside one of the fields of the equipment group, the printer A, and the printer B indicates that the process information 31 is not assigned to the operating schedule.

In the assignment area 24 illustrated in FIG. 2, the printing process 1 is displayed inside the field of the equipment group and the printing process 2 is displayed inside the field of the printer A, indicating that the printing process 1 and the printing process 2 are in an unassigned state.

Note that in the exemplary embodiment, an operating schedule expressed in units of shifts is used, but the configuration is not limited thereto. For example, an operating schedule expressed in units of hours and days or the like may also be used. In other words, the production management system 10 may also be configured to manage the operating schedule in units of hours and days or the like.

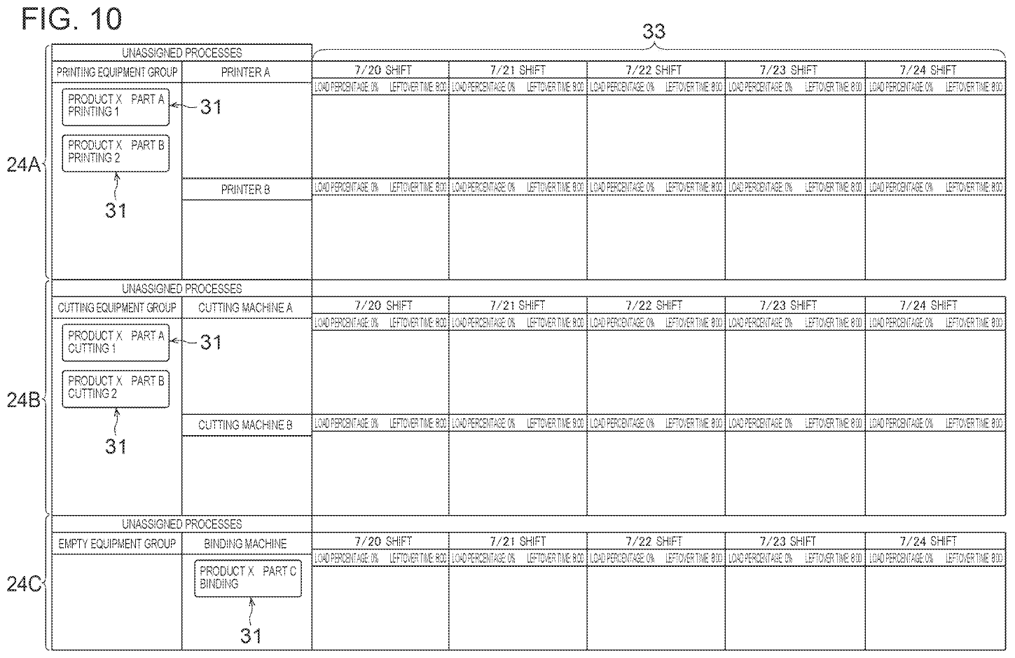

Also, on the assignment screen 20 illustrated in FIG. 2, an assignment area 24 (24A) related to printing processes is displayed, but it is possible to cause an assignment area 24B related to cutting processes and an assignment area 24C related to binding processes to be displayed by scrolling the screen (see FIG. 10).

In the assignment area 24B (see FIG. 10), a cutting equipment group (an example of an equipment group) and cutting machines A and B (an example of single pieces of equipment) are displayed as association destinations, for example. In the assignment area 24B, the operating schedule of the cutting machine A and the operating schedule of the cutting machine B are displayed as the schedule information 33, for example.

In the assignment area 24C (see FIG. 10), a binding machine (an example of a single piece of equipment) is displayed as an association destination, for example. In the assignment area 24C, the operating schedule of the binding machine is displayed as the schedule information 33.

In the menu area 23, a menu enabling the user to input instructions is displayed. Specifically, in one example, a start assignment button 81, set start date and time button 82, a set display period button (that is, a set display scale button 83), a set starting date and time button 84, and a settings button 85 are displayed.

The start assignment button 81 is a button with which the user gives an instruction to execute assignment processing. The production management system 10 executes assignment processing in response to the user using the input device 8 to performing an input operation such as clicking on the start assignment button 81.

The set start date and time button 82 is a button for giving an instruction to set the start date and time of the display period on the operating schedule of the equipment (for example, the printers A and B) displayed on the screen. On the assignment screen 20 illustrated in FIG. 2, the start date and time of the operating schedule of the equipment is set to Jul. 20, 2020.

The set display scale button 83 is a button for setting the period of the operating schedule of the equipment displayed on the screen. On the assignment screen 20 illustrated in FIG. 2, the display period of the operating schedule of the equipment is set to four days.

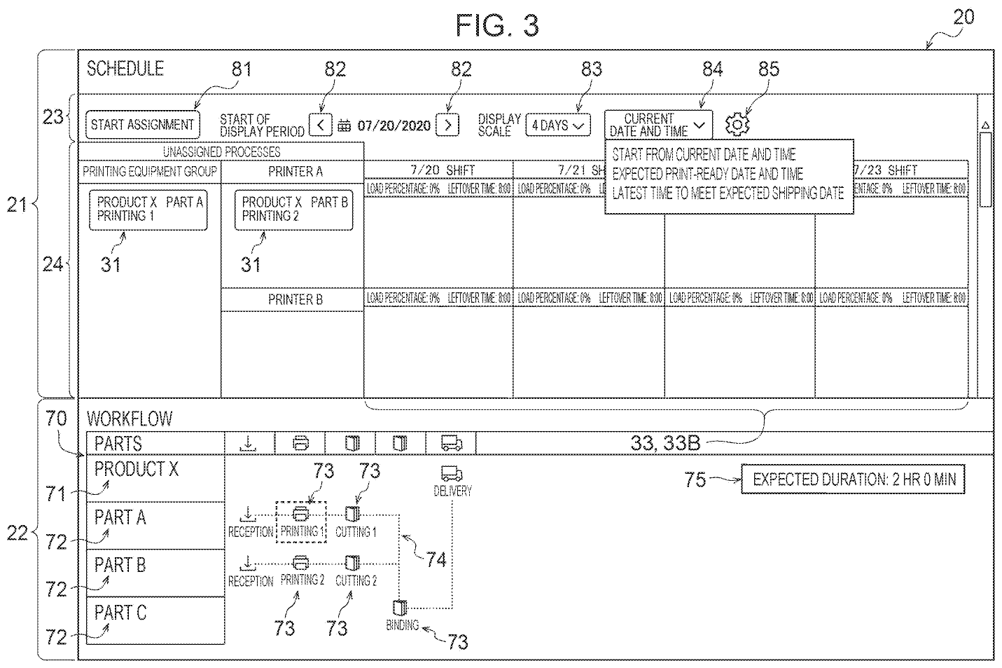

The set starting date and time button 84 is a button for giving an instruction to set the starting date and time of assigning production processes. If the user uses the input device 8 to perform an operation such as a pull-down on the set starting date and time button 84, settable starting dates and times are displayed, as illustrated in FIG. 3, and if the user performs an operation of selecting a displayed starting date and time, the starting date and time are set.

In the exemplary embodiment, for example, the starting date and time may be set to one of the following: the current date and time, the expected print-ready date and time, and the starting date and time going back a predetermined standard period from the shipping date and time of the product. Note that the current date and time are set by default as the starting date and time, for example.

The settings button 85 is a button with which the user gives an instruction to proceed to a screen for specifying various settings. If the user uses the input device 8 to perform an input operation such as clicking on the settings button 85 and to perform a screen selection operation, the screen proceeds to the grace period setting screen 40 (see FIG. 4), the equipment group setting screen 50 (see FIG. 5), and the equipment setting screen 60 (see FIG. 6) below.

Note that in the exemplary embodiment, the start assignment button 81, the set start date and time button 82, the set display scale button 83, the set starting date and time button 84, the settings button 85, and the like are used as user interface elements, but the configuration is not limited thereto, and any other user interface elements may be used insofar as the user is able to input instructions.

<Grace Period Setting Screen 40>

FIG. 4 illustrates an example of the grace period setting screen 40 displayed on the display 7. The grace period setting screen 40 is a screen on which the user gives an instruction to set a grace period from the date and time (hereinafter referred to as the starting date and time) that serves as the starting point of assigning production processes to the first production process.

The grace period is set according to a user instruction in cases in which it is desirable to have a preparatory period prior to executing the first production process, for example. For example, if the first production process is a printing process, it is conceivable to set a grace period as, among other things, a preparatory period until the text is ready to print and a preparatory period in which to prepare the paper to be used for printing.

On the grace period setting screen 40, the user uses the input device 8 to input a number of shifts and thereby give an instruction to set the grace period. Specifically, on the grace period setting screen 40, the grace period increases if the user performs an input operation such as clicking on a plus button 41 (that is, a + button), and the grace period decreases if the user performs an input operation such as clicking on a minus button 42 (that is, a − button). In the exemplary embodiment, as one example, the number of shifts may be set within the range from 0 to 200. In the exemplary embodiment, the grace period is set to 0 days by default, for example.

Note that although the exemplary embodiment is configured such that a number of shifts is inputted as the grace period, the configuration is not limited thereto. For example, in a configuration in which the operating schedule is managed in units of hours and days or the like, a number of hours and days or the like may be configured to be inputted as the grace period.

<Equipment Group Setting Screen 50>

FIG. 5 illustrates an example of the equipment group setting screen 50 displayed on the display 7. The equipment group setting screen 50 is a screen enabling the user to give instructions for specifying settings related to equipment groups.

On the equipment group setting screen 50, as one example, it is possible give instructions for setting a group name for an equipment group, setting equipment that belongs to the equipment group, and setting the priority of the equipment in the equipment group. Specifically, for example, on the equipment group setting screen 50, if the user uses the input device 8 to input a group name, an instruction to set the group name of the equipment group is given.

On the equipment group setting screen 50, as one example, the instruction to set the equipment that belongs to the equipment group is given as follows. For example, on the equipment group setting screen 50, if the user selects a piece of equipment from an equipment list and performs an input operation such as clicking on an add button 51, an instruction to add the selected piece of equipment to the equipment group is given. Also, if the user selects a piece of equipment that belongs to the equipment group (that is, a piece of equipment displayed in the “equipment in group” field) and performs an input operation such as clicking on a remove button 52, an instruction to remove the selected piece of equipment from the equipment group is given.

On the equipment group setting screen 50, as one example, an instruction to set the priority is given according to the order in which pieces of equipment are listed in the “equipment in group” field. In the exemplary embodiment, for example, the piece of equipment placed at the top in the “equipment in group” field is set to the highest priority, with the priority of equipment decreasing in order from top to bottom.

Additionally, for example, on the equipment group setting screen 50, if the user performs a move operation, such as by drag and drop, to rearrange the order of the equipment in the “equipment in group” field, an instruction to set the priority of the equipment in the equipment group is given.

<Equipment Setting Screen 60>

FIG. 6 illustrates an example of the equipment setting screen 60 displayed on the display 7. The equipment setting screen 60 is a screen enabling the user to give instructions for specifying settings related to equipment.

On the equipment setting screen 60, as one example, it is possible to give an instruction to set a grace period until the next process involving a piece of equipment. The instruction to set a grace period is given by the user when, for example, it is desirable to leave a grace period between when a production process is executed using the piece of equipment and when the next production process is to be executed. For example, if the equipment is a printer, it is conceivable to set a grace period to allow for image drying, fusing, and the like.

On the equipment setting screen 60, the user uses the input device 8 to input a number of shifts and thereby give an instruction to set the grace period. Specifically, on the equipment setting screen 60, the grace period increases if the user performs an input operation such as clicking on a plus button 61 (that is, a + button), and the grace period decreases if the user performs an input operation such as clicking on a minus button 62 (that is, a − button). In the exemplary embodiment, as one example, the number of shifts may be set within the range from 0 to 200.

In this way, in the exemplary embodiment, it is possible to set a grace period for each piece of equipment included in an equipment group. Also, in the exemplary embodiment, the grace period is set to 0 days by default, for example.

Note that on the equipment setting screen 60, it is possible to specify various settings, including the grace period, for each piece of equipment, including equipment that belongs to an equipment group. Also, although the exemplary embodiment is configured such that a number of shifts is inputted as the grace period, the configuration is not limited thereto. For example, in a configuration in which the operating schedule is managed in units of hours and days or the like, a number of hours and days or the like may be configured to be inputted as the grace period.

<Production Management System 10>

The production management system 10 is an example of an information processing apparatus, is a system that manages the production of printed material, and generates a production plan for printed material. Specifically, the production management system 10 generates a production plan for printed material on the basis of production information acquired from the order management system 6, and causes the printers 2 and the processing machines 4 to produce the printed material in accordance with the production plan.

Specifically, the production management system 10 functions as a computer and includes a processor 11, storage 12, and a memory 13, as illustrated in FIG. 1.

For the processor 11, a general-purpose processor such as a central processing unit (CPU) is used, for example. Herein, the term “processor” refers to hardware in a broad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device).

Also, in the exemplary embodiment, the term “processor” is broad enough to encompass one processor or plural processors in collaboration which are located physically apart from each other but may work cooperatively. The order of operations of the processor is not limited to one described in the exemplary embodiment above, and may be changed.

The storage 12 stores various programs, including a processing program 12A, and various data. The storage 12 is achieved specifically by a recording device such as a hard disk drive (HDD), a solid-state drive (SSD), or flash memory. Moreover, the storage 12 is not limited to being configured as a single device, and may also be configured as multiple devices provided in physically remote locations. Note that the processing program 12A is one example of an information processing program.

The memory 13 is a work area that the processor 11 uses to execute various programs, and temporarily records various programs or various data when the processor 11 executes a process. The processor 11 reads out various programs, including the processing program 12A, from the storage 12 into the memory 13, and executes the programs using the memory 13 as a work area.

In the production management system 10, the processor 11 executes a processing program to thereby achieve various functions for executing predetermined processing. Hereinafter, a functional configuration achieved through cooperation between the processor 11 serving as a hardware resource and the processing program serving as a software resource will be described.

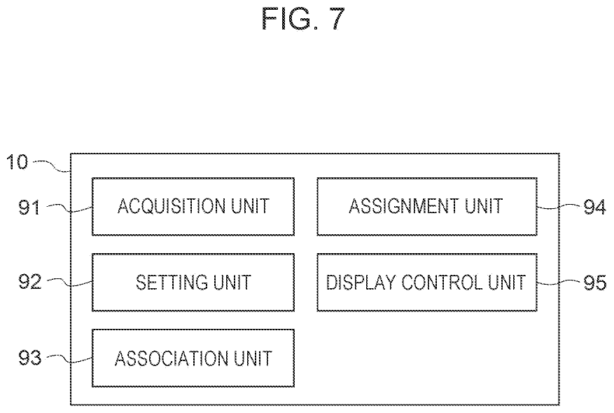

FIG. 7 is a block diagram illustrating an example of a functional configuration of the production management system 10 according to the exemplary embodiment. In one example, as illustrated in FIG. 7, the production management system 10 is provided with an acquisition unit 91, a setting unit 92, an association unit 93, an assignment unit 94, and a display control unit 95.

The acquisition unit 91 acquires process information sent from the order management system 6 and instruction information inputted via the input device 8. The instruction information inputted via the input device 8 may be instruction information inputted on the assignment screen 20 (see FIG. 2), the grace period setting screen 40 (see FIG. 4), the equipment group setting screen 50 (see FIG. 5), and the equipment setting screen 60 (see FIG. 6).

The setting unit 92 sets, on the basis of instruction information inputted on the grace period setting screen 40 (see FIG. 4), a grace period from the starting date and time that serves as the starting point of assigning production processes to the first production process.

Additionally, the setting unit 92 sets, on the basis of instruction information inputted on the equipment setting screen 60 (see FIG. 6), a grace period for each piece of equipment, including equipment belonging to an equipment group.

The setting unit 92 also sets, on the basis of instruction information inputted on the assignment screen 20 (see FIG. 2), the starting date and time of assigning production processes to a starting date and time going back a predetermined standard period from the shipping date and time of the product. In one example, the standard period is the period obtained by adding up the grace periods of equipment capable of executing the production processes to be assigned.

The association unit 93 associates, on the basis of production information and instruction information, a production process with an equipment group or a single piece of equipment. For instance, in an assignment area 24A (see FIG. 10) related to printing processes, the association unit 93 associates, on the basis of production information and instruction information, each of the printing process 1 and the printing process 2 with one of a printing equipment group, the printer A, and the printer B, for example. In an assignment area 24B (see FIG. 10) related to cutting processes, the association unit 93 associates, on the basis of production information and instruction information, each of a cutting process 1 and a printing process 2 with one of a cutting equipment group, the cutting machine A, and the cutting machine B, for example. In an assignment area 24C (see FIG. 10) related to binding processes, the association unit 93 associates, on the basis of production information and instruction information, a cutting process with a binding machine, for example.

In this way, in the exemplary embodiment, the association unit 93 is capable of associating a production process with one of either an equipment group or a single piece of equipment.

If the association unit 93 associates a production process with an equipment group, the assignment unit 94 assigns, on the basis of a predetermined condition, the production process to the operating schedule of one of multiple pieces of equipment belonging to the equipment group.

The predetermined condition above is the priority for the multiple pieces of equipment belonging to the equipment group, and if there is an opening in the operating schedule of the equipment with the highest priority, the assignment unit 94 assigns the production process to that operating schedule.

If there is no opening in the operating schedule of the equipment with the highest priority, but there is an opening in the operating schedule of the equipment with the next-highest priority, the assignment unit 94 assigns the production process to that operating schedule.

Also, if the association unit 93 associates a production process with a single piece of equipment, the assignment unit 94 assigns, on the basis of a predetermined condition, the production process to the operating schedule of that piece of equipment.

Also, if the association unit 93 associates each of multiple production processes with each of an equipment group and a single piece of equipment, the assignment unit 94 assigns, on the basis of a predetermined condition, the production process associated with the single piece of equipment to the operating schedule of that piece of equipment, and then assigns, on the basis of a predetermined condition, the production process associated with the equipment group to the operating schedule of one of the multiple pieces of equipment.

If the setting unit 92 has set a grace period from the starting date and time to the first production process, the assignment unit 94 assigns the first production process to the operating schedule of equipment so as to leave the grace period open.

If a given production process is assigned to the operating schedule of equipment for which a grace period is set, the assignment unit 94 assigns the next production process after the given production process to the operating schedule of the equipment so as to leave the grace period open.

If a first production process and a second production process are assigned as production processes to the operating schedule of equipment for which grace periods have been set, the assignment unit 94 assigns a third production process to be executed next after the first and second production processes to the operating schedule of the equipment on or after the latest endpoint from among the endpoints of the grace periods of the equipment to which each of the first and second production processes is assigned.

If the setting unit 92 sets the starting date and time of assigning production processes to a starting date and time going back a predetermined period from the shipping date and time of the product and the association unit 93 has associated a production process with an equipment group, the assignment unit 94 assigns that production process to the operating schedule of one of the multiple pieces of equipment, using the starting date and time as the starting point.

The display control unit 95 is a functional unit that controls the displaying of information on the display 7. The display control unit 95 causes display screens such as the assignment screen 20 (see FIG. 2), the grace period setting screen 40 (see FIG. 4), the equipment group setting screen 50 (see FIG. 5), and the equipment setting screen 60 (see FIG. 6) to be displayed. The display control unit 95 also causes the display 7 to display process information 31 on the basis of the results of associations made by the association unit 93 and the results of assignments made by the assignment unit 94.

<Assignment Processing According to Exemplary Embodiment>

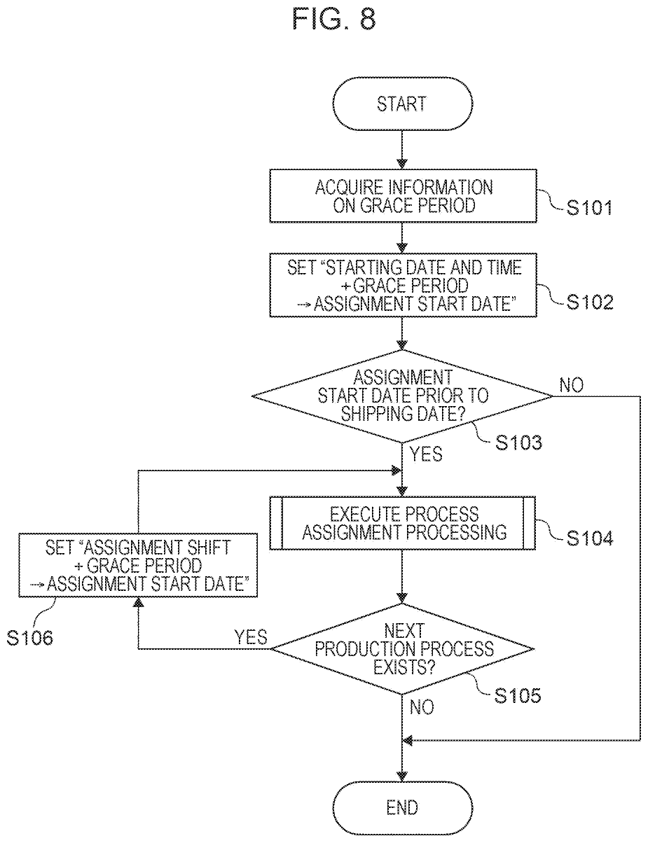

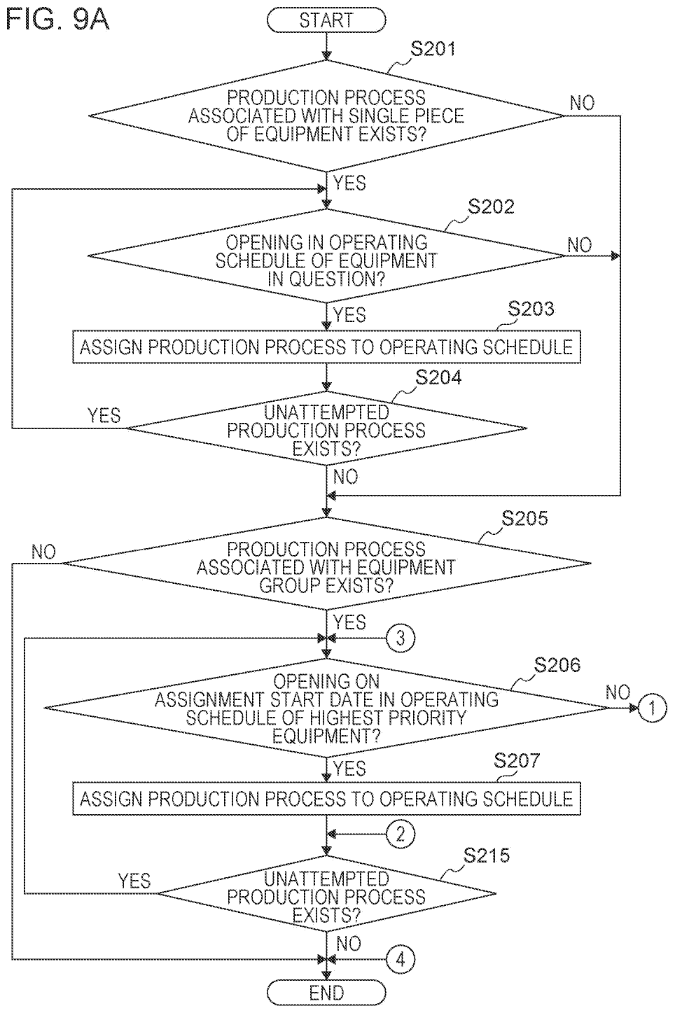

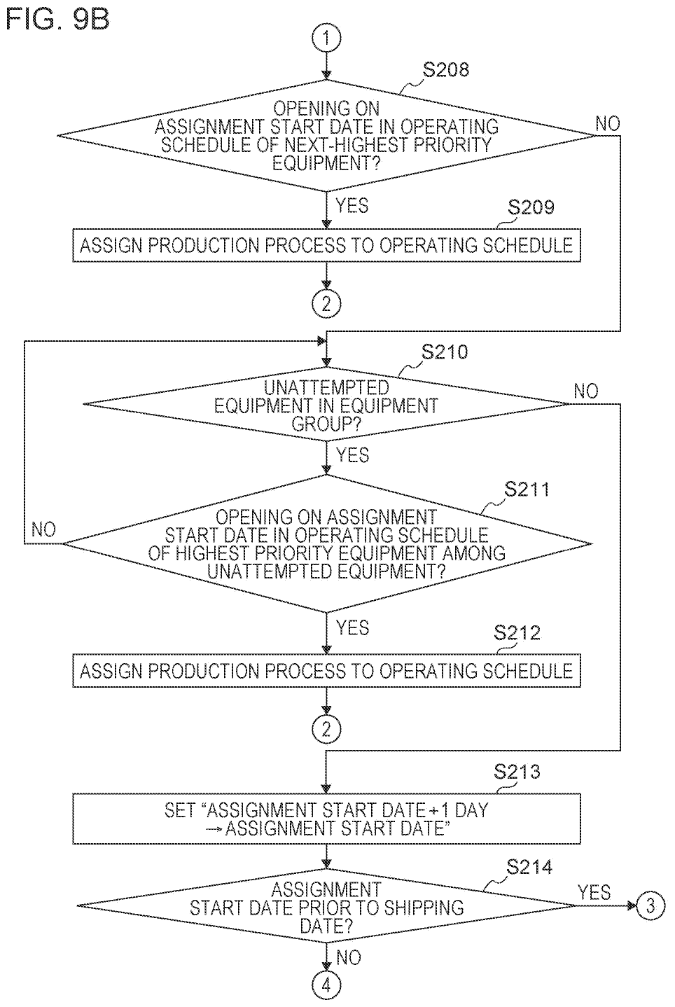

Next, an example of assignment processing according to the exemplary embodiment will be described. FIGS. 8, 9A, and 9B are flowcharts illustrating an example of the flow of assignment processing executed by the production management system 10 according to the exemplary embodiment.

The processing is performed by having the processor 11 read out and execute the processing program 12A from the storage 12. In one example, the execution of the processing is initiated when the processor 11 is instructed to execute assignment processing (that is, when the start assignment button 81 is operated).

As illustrated in FIG. 8, when the processing is initiated, first, the processor 11 acquires information on a grace period from the starting date and time to the first production process (step S101). Note that, as described above, the starting date and time are set to one of the following: the current date and time, the expected print-ready date and time, and the starting date and time going back a predetermined standard period from the shipping date and time of the product.

Next, the processor 11 sets the date after the grace period from the starting date and time as the assignment start date (step S102).

Next, the processor 11 determines whether the assignment start date is prior to the shipping date (step S103).

In the case of determining that the assignment start date is later than the shipping date (step S103: NO), the processor 11 ends the processing without assigning production processes. Note that in this case, process information 31 is displayed in the field of any of the equipment group, the printer A, and the printer B to indicate an unassigned state.

In the case of determining that the assignment start date is prior to the shipping date (step S103: YES), the processor 11 executes processing (hereinafter referred to as process assignment processing) for assigning the first production process to the operating schedule of equipment (step S104). In the exemplary embodiment, the first production process is a printing process (specifically, the printing process 1 and the printing process 2) associated with the printing equipment group or a printer (specifically, the printers A and B).

Note that if multiple processes are to be executed in parallel as a production process, the multiple processes are included in the production process. In the exemplary embodiment, since the printing process 1 and the printing process 2 are to be executed in parallel as the first production process, the printing process 1 and the printing process 2 are included in the first production process.

In the process assignment processing, as illustrated in FIGS. 9A and 9B, the processor 11 determines whether a production process associated with a single piece of equipment (in the exemplary embodiment, the printer A or B) exists as the production process (hereinafter referred to as the current production process) to be assigned (step S201).

In the case of determining that a production process associated with a single piece of equipment exists (step S201: YES), the processor 11 proceeds to step S202, whereas in the case of determining that a production process associated with a single piece of equipment does not exist (step S201: NO), the processor 11 proceeds to step S205.

In step S202, the processor 11 determines whether there is an opening on or after the assignment start date and prior to the shipping date in the operating schedule of the equipment (hereinafter referred to as the equipment in question) with which the current production process to be assigned is associated and to which the current production process is to be assigned.

In the case of determining that there is an opening on or after the assignment start date and prior to the shipping date in the operating schedule of the equipment in question (step S202: YES), the processor 11 assigns the current production process to the earliest opening on or after the assignment start date and prior to the shipping date in the operating schedule (step S203) and proceeds to step S204.

In the case of determining that there is not an opening on or after the assignment start date and prior to the shipping date in the operating schedule of the equipment to which the current production process is to be assigned (step S202: NO), the processor 11 proceeds to step S204 without assigning the current production process.

In step S204, the processor 11 determines whether a production process for which the process assignment processing has not been attempted exists among the production processes associated with a single piece of equipment.

In the case of determining that a production process for which the process assignment processing has not been attempted exists among the production processes associated with a single piece of equipment (step S204: YES), the processor 11 executes step S202 for that production process.

In the case of determining that a production process for which the process assignment processing has not been attempted does not exist among the production processes associated with a single piece of equipment (step S204: NO), the processor 11 proceeds to step S205.

In step S205, the processor 11 determines whether a production process associated with an equipment group exists. In the case of determining that a production process associated with an equipment group exists (step S205: YES), the processor 11 proceeds to step S206, whereas in the case of determining that a production process associated with an equipment group does not exist (step S205: NO), the processor 11 ends the process assignment processing for the first production process and proceeds to step S105 (see FIG. 8).

In step S206, the processor 11 determines whether there is an opening on the assignment start date in the operating schedule of the equipment with the highest priority in the equipment group.

In the case of determining that there is an opening on the assignment start date in the operating schedule of the equipment with the highest priority in the equipment group (step S206: YES), the processor 11 assigns the current production process on the assignment start date in that operating schedule (step S207) and proceeds to step S215.

In the case of determining that there is not an opening on the assignment start date in the operating schedule of the equipment with the highest priority in the equipment group (step S206: NO), the processor 11 determines whether there is an opening on the assignment start date in the operating schedule of the equipment with the next-highest priority in the equipment group (step S208).

In the case of determining that there is an opening on the assignment start date in the operating schedule of the equipment with the next-highest priority in the equipment group (step S208: YES), the processor 11 assigns the current production process on the assignment start date in that operating schedule (step S209) and proceeds to step S215.

In the case of determining that there is not an opening on the assignment start date in the operating schedule of the equipment with the next-highest priority in the equipment group (step S208: NO), the processor 11 determines whether equipment for which the process assignment processing has not been attempted exists in the equipment group (step S210).

In the case of determining that equipment for which the process assignment processing has not been attempted exists in the equipment group (step S210: YES), the processor 11 proceeds to step S211, whereas in the case of determining that equipment for which the process assignment processing has not been attempted does not exist in the equipment group (step S210: NO), the processor 11 proceeds to step S213.

In step S211, the processor 11 determines whether there is an opening on the assignment start date in the operating schedule of the equipment with the highest priority among the equipment for which the process assignment processing has not been attempted.

In the case of determining that there is an opening on the assignment start date in the operating schedule of the equipment with the highest priority among the equipment for which the process assignment processing has not been attempted (step S211: YES), the processor 11 assigns the current production process on the assignment start date in that operating schedule (step S212) and proceeds to step S215.

In the case of determining that there is not an opening on the assignment start date in the operating schedule of the equipment with the highest priority among the equipment for which the process assignment processing has not been attempted (step S211: NO), the processor 11 returns to step S210.

In step S213, the date obtained by adding one day (one shift) to the assignment start date is set as the assignment start date, and then it is determined whether the assignment start date is prior to the shipping date (step S214).

In the case of determining that the assignment start date is later than the shipping date (step S214: NO), the processor 11 ends the processing without assigning production processes, and proceeds to step S105.

In the case of determining that the assignment start date is prior to the shipping date (step S214: YES), the processor 11 proceeds to step S206.

In step S215, the processor 11 determines whether a production process for which the process assignment processing has not been attempted exists among the production processes associated with an equipment group.

In the case of determining that a production process for which the process assignment processing has not been attempted exists among the production processes associated with an equipment group (step S215: YES), the processor 11 executes step S206 for that production process.

In the case of determining that a production process for which the process assignment processing has not been attempted does not exist among the production processes associated with an equipment group (step S215: NO), the processor 11 ends the processing and proceeds to step S205.

In step S105, the processor 11 determines whether a next production process after the current production process exists. In the case of determining that the next production process exists (step S105: YES), the processor 11 sets the date obtained by adding the grace period set for the equipment to which the current production process is assigned to the shift of that equipment as the assignment start date (step S106) and executes the process assignment processing for the next production process (step S104).

Note that in step S106, if there are multiple dates obtained by adding the grace period set for the equipment to which the current production process is assigned to the shift of that equipment, the latest date is set as the assignment start date.

In the exemplary embodiment, the next production process is a cutting process (specifically, the cutting process 1 and the cutting process 2) associated with the cutting equipment group or a cutting machine (specifically, the cutting machines A and B). The process assignment processing for the next production process is performed in a similar way as the process assignment processing for the first production process, and therefore a description is omitted.

In the case of determining that the next production process does not exist (step S105: NO), the processor 11 ends the processing.

### First Specific Example of Assignment Processing

In a first specific example, as illustrated in FIG. 10, the processor 11 associates the printing process 1 and the printing process 2 as the first production process with the printing equipment group as the equipment group. Also, in the first specific example, the processor 11 associates the cutting process 1 and the cutting process 2 as the next production process after the printing processes 1 and 2 with the cutting equipment group as the equipment group. Furthermore, in the first specific example, the processor 11 associates the binding process as the next production process after the cutting processes 1 and 2 with the binding machine. Note that the binding machine does not belong to an equipment group.

In the first specific example, it is assumed that various settings have been specified by the processor 11 as follows. Namely, in the first specific example, the current date and time are set as the starting date and time. Note that the current date and time are assumed to be 7/20, and the expected shipping date is assumed to be on or after 7/25. Furthermore, in the first specific example, the grace period from the starting date and time to the first production process is set to 0 shifts (0 days), and for all equipment, the grace period until the next process involving the equipment is set to 0 shifts (0 days).

In the first specific example, in the printing equipment group, the printer A is set as the equipment with the highest priority and the printer B is set as the equipment with the next-highest priority. Also, in the first specific example, in the cutting equipment group, the cutting machine A is set as the equipment with the highest priority and the cutting machine B is set as the equipment with the next-highest priority.

Note that in FIGS. 10 to 18, the assignment area 24A related to printing processes, the assignment area 24B related to cutting processes, and the assignment area 24C related to binding processes are illustrated. Also, in FIGS. 10 to 18, the printing process 1, the printing process 2, the cutting process 1, the cutting process 2, and the binding process are each displayed as process information 31 in the form of a virtual card.

If an instruction to execute assignment processing is given, the processor 11 first executes the process assignment processing for the printing processes 1 and 2, which are the first production process. In the first specific example, since the current date and time are set as the starting date and time and the grace period from the starting date and time to the first production process is set to 0 shifts, the current date and time of 7/20 is the assignment start date for the printing processes 1 and 2.

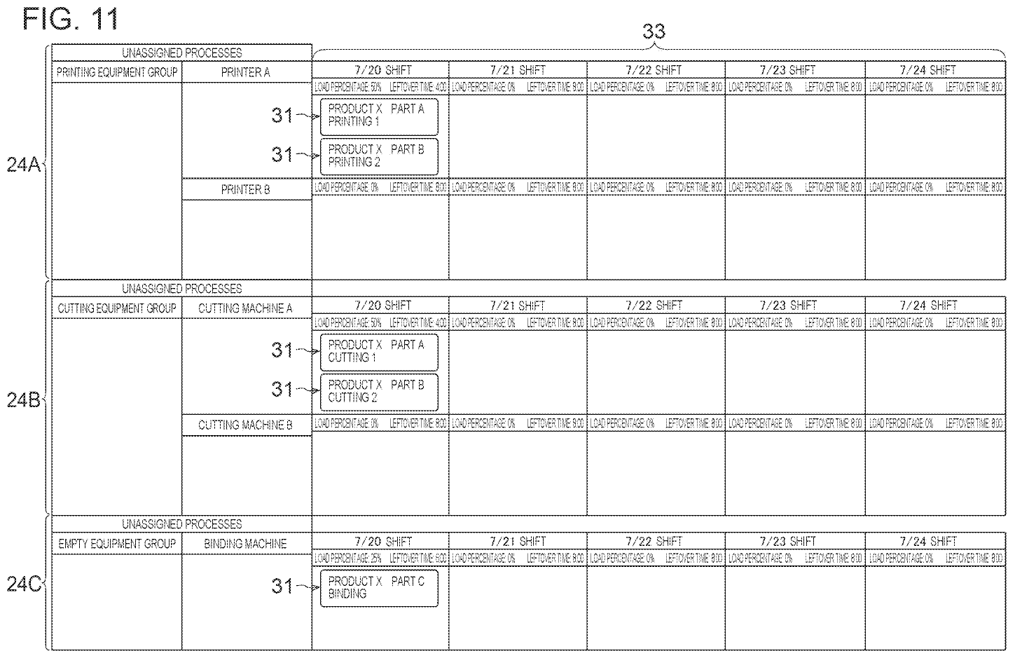

As illustrated in FIG. 11, since there is an opening in the 7/20 shift of the printer A, which is the equipment with the highest priority in the printing equipment group, the processor 11 assigns the printing process 1 to the 7/20 shift of the printer A. Furthermore, since there is an opening in the 7/20 shift of the printer A, which is the equipment with the highest priority in the printing equipment group, the processor 11 assigns the printing process 2 to the 7/20 shift of the printer A.

The case in which there is an opening in a shift means that the leftover time in the shift is equal to or greater than the duration of the production process, whereas the case in which there is not an opening in a shift means that the leftover time in the shift is less than the duration of the production process.

Next, the processor 11 executes the process assignment processing for the cutting processes 1 and 2, which are the next production process after the printing processes 1 and 2. In the first specific example, for all equipment, the grace period until the next process involving the equipment is set to 0 shifts, and therefore the assignment start date for the cutting process is 7/20, the date on which the printing processes 1 and 2 are assigned.

As illustrated in FIG. 11, since there is an opening in the 7/20 shift of the cutting machine A, which is the equipment with the highest priority in the cutting equipment group, the processor 11 assigns the cutting process 1 to the 7/20 shift of the cutting machine A. Furthermore, since there is an opening in the 7/20 shift of the cutting machine A, which is the equipment with the highest priority in the cutting equipment group, the processor 11 assigns the cutting process 2 to the 7/20 shift of the cutting machine A.

Next, the processor 11 executes the process assignment processing for the binding process, which is the next production process after the cutting processes 1 and 2. In the first specific example, for all equipment, the grace period until the next process involving the equipment is set to 0 shifts, and therefore the assignment start date for the binding process is 7/20, the date on which the cutting processes 1 and 2 are assigned.

As illustrated in FIG. 11, since there is an opening in the 7/20 shift of the binding machine, the processor 11 assigns the binding process to the 7/20 shift of the binding machine.

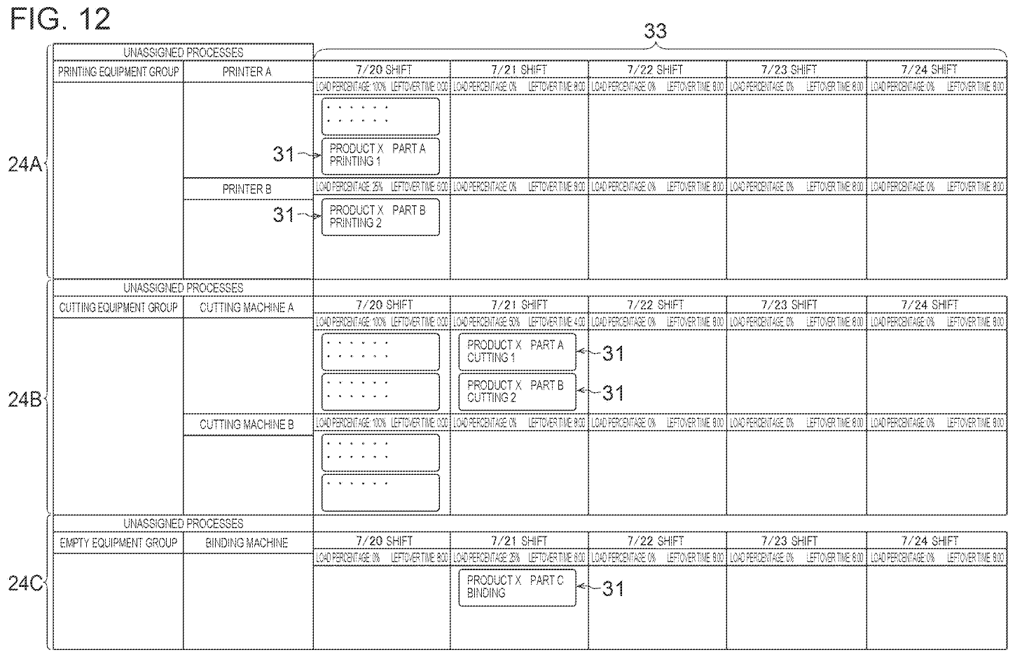

If, as illustrated in FIG. 12, for example, there are no more openings in the 7/20 shift of the printer A due to assigning the printing process 1 to the 7/20 shift of the printer A, but there is an opening in the 7/20 shift of the printer B, which is the equipment with the next-highest priority, the processor 11 assigns the printing process 2 to the 7/20 shift of the printer B.

Furthermore, if, as illustrated in FIG. 12, there are no openings in the 7/20 shift of the cutting machine A and the 7/20 shift of the cutting machine B, but there is an opening in the 7/21 shift of the cutting machine A, which is the equipment with the highest priority in the cutting equipment group, the processor 11 assigns the cutting process 1 to the 7/21 shift of the cutting machine A.

Also, if there is an opening in the 7/21 shift of the cutting machine A, which is the equipment with the highest priority in the cutting equipment group, the processor 11 assigns the cutting process 2 to the 7/21 shift of the cutting machine A. Suppose that there are also no openings in the 7/21 shift of the cutting machine A, which is the equipment with the highest priority in the cutting equipment group; in this case, if there is an opening in the 7/21 shift of the cutting machine B, which is the equipment with the next-highest priority in the cutting equipment group, the processor 11 assigns the cutting process 2 to the 7/21 shift of the cutting machine B.

In this case, the assignment start date for the binding process is 7/21, the date on which the cutting processes 1 and 2 are assigned, and if there is an opening in the 7/21 shift of the binding machine, the processor 11 assigns the binding process to the 7/21 shift of the binding machine.

As above, in the first specific example, if a production process is associated with an equipment group, the processor 11 assigns, on the basis of a predetermined condition, the production process to the operating schedule of one of multiple pieces of equipment belonging to the equipment group.

The predetermined condition above is the priority for the multiple pieces of equipment belonging to the equipment group, and if there is an opening in the operating schedule of the equipment with the highest priority, the processor 11 assigns the production process to that operating schedule.

Also, if there is no opening in the operating schedule of the equipment with the highest priority, but there is an opening in the operating schedule of the equipment with the next-highest priority, the processor 11 assigns the production process to that operating schedule.

### Second Specific Example of Assignment Processing

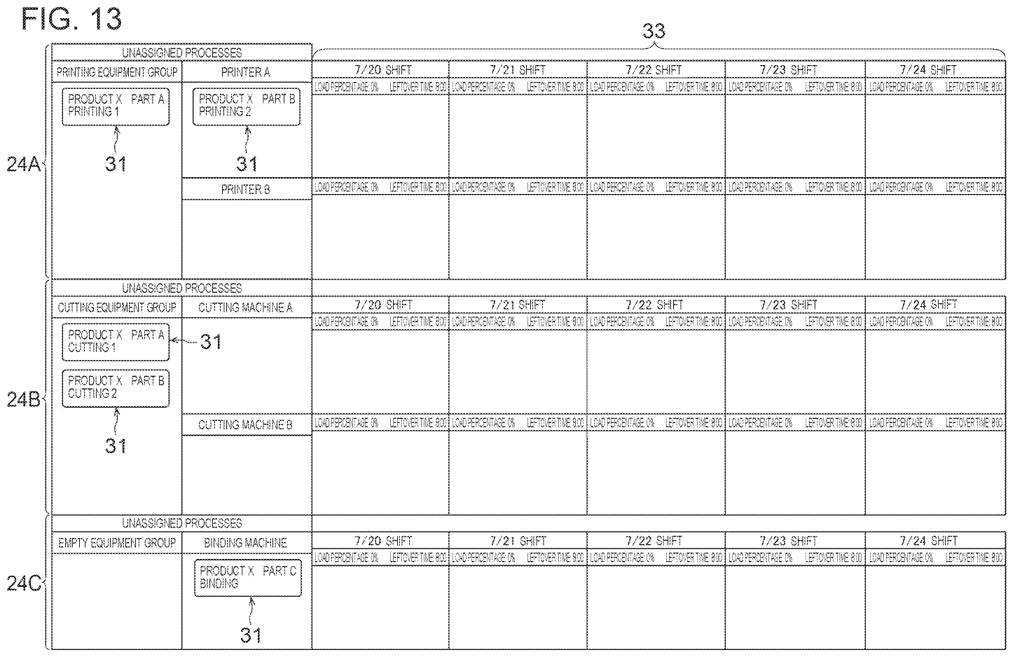

In a second specific example, as illustrated in FIG. 13, the processor 11 associates the printing process 1 with the printing equipment group and associates the printing process 2 with the printer A. Note that in the second specific example, the other conditions are similar to the first specific example.

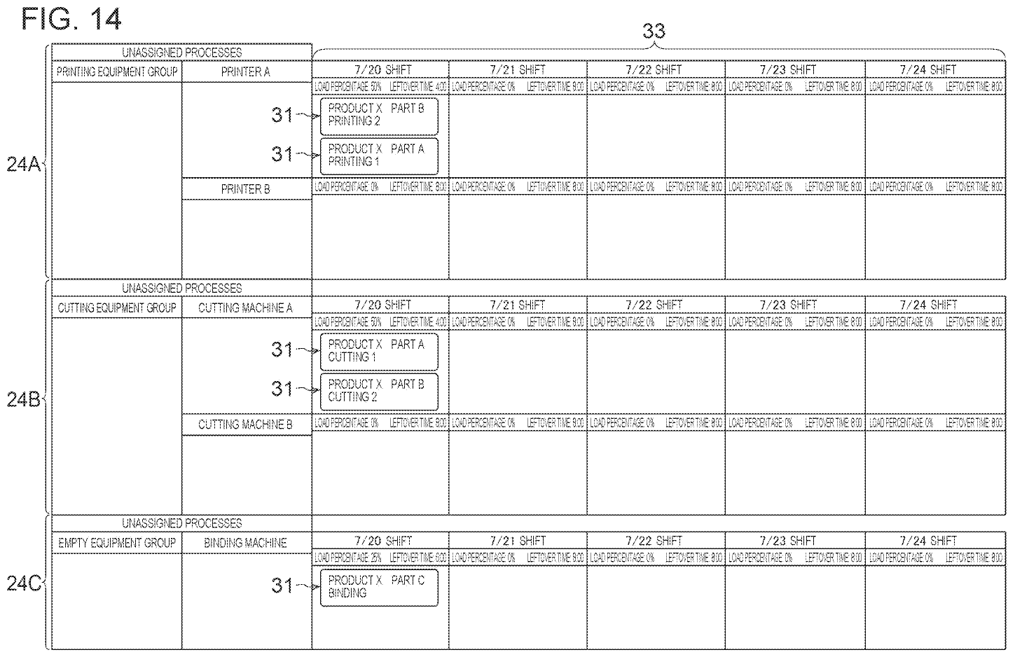

In the second specific example, as illustrated in FIG. 14, if an instruction to execute assignment processing is given, the processor 11 first executes the process assignment processing for the printing process 2 associated with the printer A, which is an example of a single piece of equipment. As illustrated in FIG. 14, since there is an opening in the 7/20 shift of the printer A, the processor 11 assigns the printing process 2 to the 7/20 shift of the printer A.

Next, the processor 11 executes the process assignment processing for the printing process 1 associated with the printing equipment group.

As illustrated in FIG. 14, since there is an opening in the 7/20 shift of the printer A, which is the equipment with the highest priority in the printing equipment group, the processor 11 assigns the printing process 1 to the 7/20 shift of the printer A.

Suppose that there are no more openings in the 7/20 shift of the printer A due to assigning the printing process 2 to the 7/20 shift of the printer A; in this case, if there is an opening in the 7/20 shift of the printer B, which is the equipment with the next-highest priority, the processor 11 assigns the printing process 1 to the 7/20 shift of the printer B.

In the second specific example, assignment process is executed similarly as in the first specific example for the cutting processes 1 and 2 and the binding process.

As above, in the second specific example, if a production process is associated with a single piece of equipment, the processor 11 assigns, on the basis of a predetermined condition, the production process to the operating schedule of that equipment.

Also, in the second specific example, if each of multiple production processes is associated with each of an equipment group and a single piece of equipment, the processor 11 assigns, on the basis of a predetermined condition, the production process associated with the single piece of equipment to the operating schedule of that piece of equipment, and then assigns, on the basis of a predetermined condition, the production process associated with the equipment group to the operating schedule of one of the multiple pieces of equipment.

Note that in the second specific example, the processor 11 executes the process assignment processing for the printing process 1 associated with the printing equipment group after executing the process assignment processing for the printing process 2 associated with the printer A, which is an example of a single piece of equipment, but the processor 11 is not limited thereto. For example, the processor 11 may also be configured to execute the process assignment processing for the printing process 2 associated with the printer A, which is an example of a single piece of equipment, after executing the process assignment processing for the printing process 1 associated with the printing equipment group.

### Third Specific Example of Assignment Processing

In a third specific example, the grace period from the starting date and time to the first production process is set to 1 shift. Note that in the third specific example, the other conditions are similar to the first specific example.

In the third specific example, if an instruction to execute assignment processing is given, the processor 11 first executes the process assignment processing for the printing processes 1 and 2, which are the first production process.

In the third specific example, since the current date and time are set as the starting date and time and the grace period from the starting date and time to the first production process is set to 1 shift, 7/21, which is the date obtained by adding 1 shift (1 day) to the current date and time, is the assignment start date for the printing processes 1 and 2.

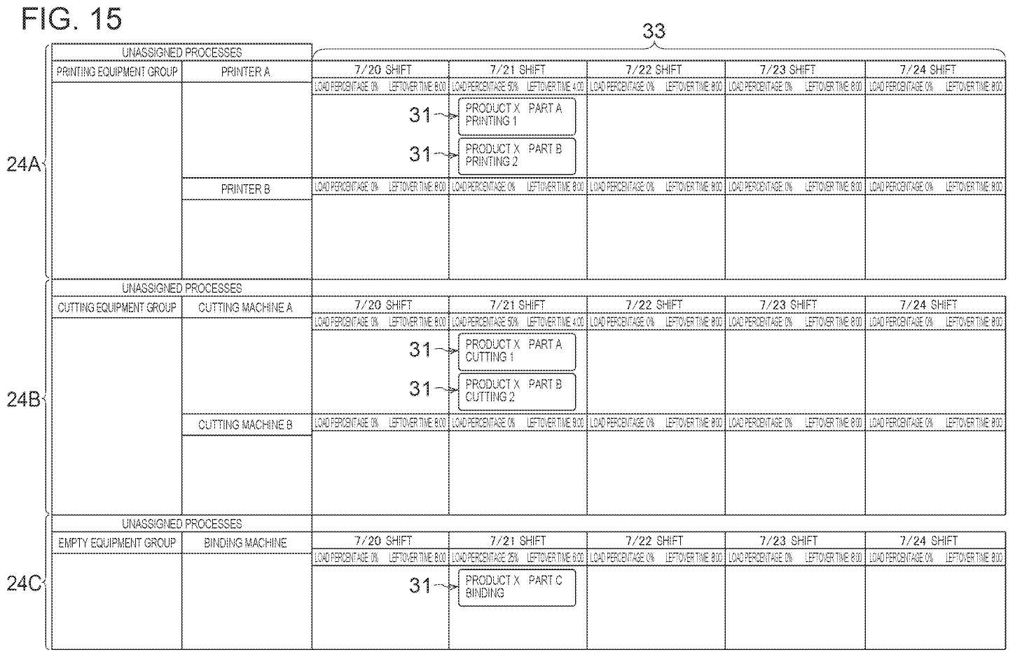

As illustrated in FIG. 15, since there is an opening in the 7/21 shift of the printer A, which is the equipment with the highest priority in the printing equipment group, the processor 11 assigns the printing process 1 to the 7/21 shift of the printer A. Furthermore, since there is an opening in the 7/21 shift of the printer A, which is the equipment with the highest priority in the printing equipment group, the processor 11 assigns the printing process 2 to the 7/21 shift of the printer A.

Next, the processor 11 executes the process assignment processing for the cutting processes 1 and 2, which are the next production process after the printing processes 1 and 2. In the third specific example, for all equipment, the grace period until the next process involving the equipment is set to 0 shifts, and therefore the assignment start date for the cutting process is 7/21, the date on which the printing processes 1 and 2 are assigned.

As illustrated in FIG. 15, since there is an opening in the 7/21 shift of the cutting machine A, which is the equipment with the highest priority in the cutting equipment group, the processor 11 assigns the cutting process 1 to the 7/21 shift of the cutting machine A. Furthermore, since there is an opening in the 7/21 shift of the cutting machine A, which is the equipment with the highest priority in the cutting equipment group, the processor 11 assigns the cutting process 2 to the 7/21 shift of the cutting machine A.

Next, the processor 11 executes the process assignment processing for the binding process, which is the next production process after the cutting processes 1 and 2. In the third specific example, for all equipment, the grace period until the next process involving the equipment is set to 0 shifts, and therefore the assignment start date for the binding process is 7/21, the date on which the cutting processes 1 and 2 are assigned.

As illustrated in FIG. 15, since there is an opening in the 7/21 shift of the binding machine, the processor 11 assigns the binding process to the 7/21 shift of the binding machine.

As above, in the third specific example, if a grace period from the starting date and time to the first production process is set, the processor 11 assigns the first production process to the operating schedule of equipment so as to leave the grace period open.

### Fourth Specific Example of Assignment Processing

In a fourth specific example, for each piece of equipment, a grace period until the next process involving the equipment is set as follows, for example.
Printer A: 1 shift
Printer B: 2 shifts
Cutting machine A: 2 shifts
Cutting machine B: 1 shift

Note that in the fourth specific example, the other conditions are similar to the first specific example.

In the fourth specific example, if an instruction to execute assignment processing is given, the processor 11 first executes the process assignment processing for the printing processes 1 and 2, which are the first production process. In the fourth specific example, since the current date and time are set as the starting date and time and the grace period from the starting date and time to the first production process is set to 0 shifts, the current date and time of 7/20 is the assignment start date for the printing processes 1 and 2.

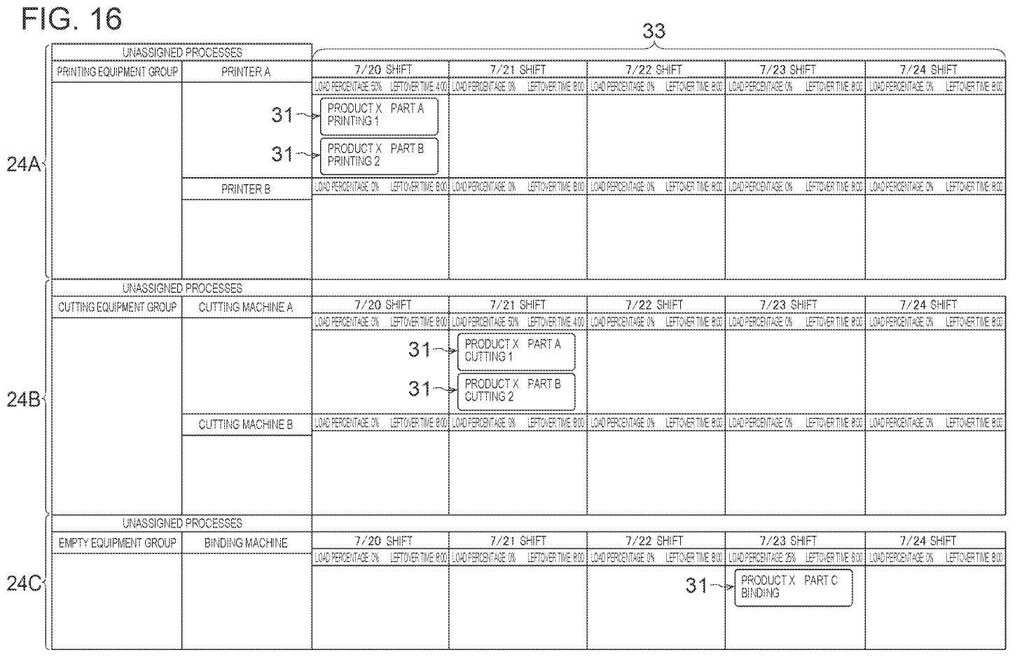

As illustrated in FIG. 16, since there is an opening in the 7/20 shift of the printer A, which is the equipment with the highest priority in the printing equipment group, the processor 11 assigns the printing process 1 to the 7/20 shift of the printer A. Furthermore, since there is an opening in the 7/20 shift of the printer A, which is the equipment with the highest priority in the printing equipment group, the processor 11 assigns the printing process 2 to the 7/20 shift of the printer A.

Next, the processor 11 executes the process assignment processing for the cutting processes 1 and 2, which are the next production process after the printing processes 1 and 2. In the fourth specific example, the grace period until the next process involving the printer A is set to 1 shift, and therefore the assignment start date for the cutting process is 7/21, the date one day after 7/20 on which the printing processes 1 and 2 are assigned.

As illustrated in FIG. 16, since there is an opening in the 7/21 shift of the cutting machine A, which is the equipment with the highest priority in the cutting equipment group, the processor 11 assigns the cutting process 1 to the 7/21 shift of the cutting machine A. Furthermore, since there is an opening in the 7/21 shift of the cutting machine A, which is the equipment with the highest priority in the cutting equipment group, the processor 11 assigns the cutting process 2 to the 7/21 shift of the cutting machine A.

Next, the processor 11 executes the process assignment processing for the binding process, which is the next production process after the cutting processes 1 and 2. In the fourth specific example, the grace period until the next process involving the cutting machine A is set to 2 shifts, and therefore the assignment start date for the binding process is 7/22, the date two days after 7/21 on which the cutting processes 1 and 2 are assigned.

As illustrated in FIG. 16, since there is an opening in the 7/23 shift of the binding machine, the processor 11 assigns the binding process to the 7/23 shift of the binding machine.

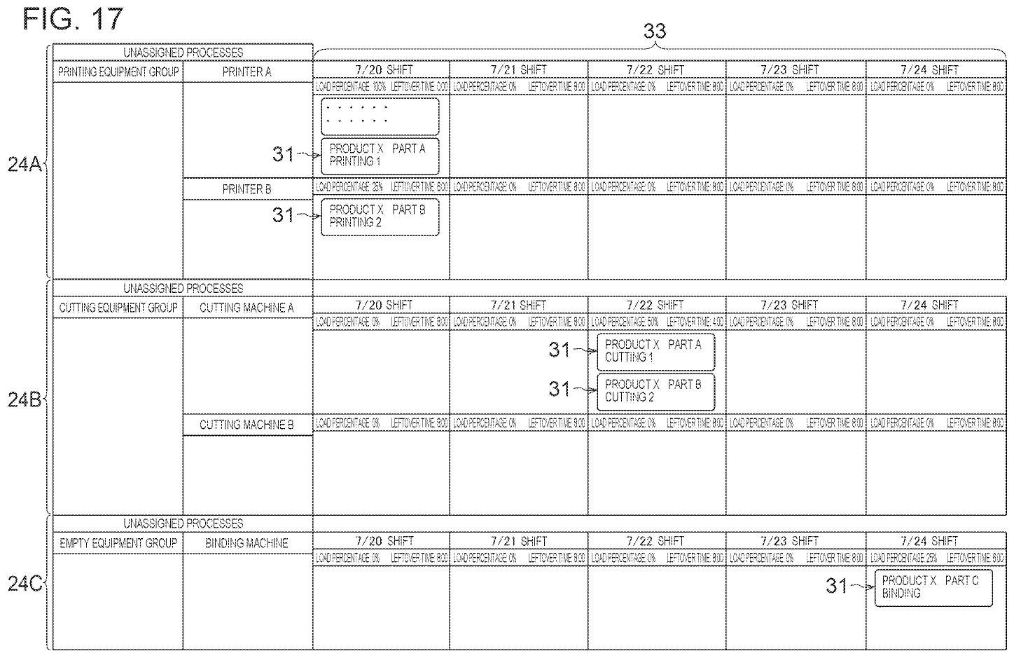

If, as illustrated in FIG. 17, for example, there are no more openings in the 7/20 shift of the printer A due to assigning the printing process 1 to the 7/20 shift of the printer A, but there is an opening in the 7/20 shift of the printer B, which is the equipment with the next-highest priority, the processor 11 assigns the printing process 2 to the 7/20 shift of the printer B.

In this case, the grace period until the next process involving the printer B is set to 2 shifts, and therefore the assignment start date for the cutting process is 7/22, the date two days after 7/20 on which the printing process 2 is assigned.

That is, the assignment target date (7/22) is set to the latest endpoint from among the endpoint (7/21) of the grace period of the printer A to which the printing process 1 (an example of a first production process) is assigned as the endpoint (7/22) of the printer B to which the printing process 2 (an example of a second production process) is assigned, and the process assignment processing is executed for the cutting process (an example of a third production process).

As illustrated in FIG. 17, since there is an opening in the 7/22 shift of the cutting machine A, which is the equipment with the highest priority in the cutting equipment group, the processor 11 assigns the cutting process 1 to the 7/22 shift of the cutting machine A. Furthermore, since there is an opening in the 7/22 shift of the cutting machine A, which is the equipment with the highest priority in the cutting equipment group, the processor 11 assigns the cutting process 2 to the 7/22 shift of the cutting machine A.

Next, the processor 11 executes the process assignment processing for the binding process, which is the next production process after the cutting processes 1 and 2. In the fourth specific example, the grace period until the next process involving the cutting machine A is set to 2 shifts, and therefore the assignment start date for the binding process is 7/24, the date two days after 7/22 on which the cutting processes 1 and 2 are assigned.

As illustrated in FIG. 17, since there is an opening in the 7/24 shift of the binding machine, the processor 11 assigns the binding process to the 7/24 shift of the binding machine.

As above, in the fourth specific example, the processor 11 sets a grace period for each piece of equipment, including equipment belonging to an equipment group, and if a given production process is assigned to the operating schedule of equipment for which a grace period is set, the processor 11 assigns the next production process after the given production process to the operating schedule of the equipment so as to leave the grace period open.

Additionally, in the fourth specific example, if a first production process and a second production process are assigned as production processes to the operating schedule of equipment for which grace periods are set, the processor 11 assigns a third production process to be executed next after the first and second production processes to the operating schedule of the equipment on or after the latest endpoint from among the endpoints of the grace periods of the equipment to which each of the first and second production processes is assigned.

As above, in the process assignment processing for the cutting processes 1 and 2 according to the fourth specific example, the highest priority cutting machine in the cutting equipment group is the cutting machine A, and therefore assignment is initially attempted with the cutting machine A. However, since the grace period of the cutting machine A is set to 2 shifts whereas the grace period of the cutting machine B is set to 1 shift, if production processes are assigned to the cutting machine A, the production time may be increased in some cases.

Accordingly, if each of multiple production processes is associated with each of multiple equipment groups, each of the multiple production processes may be assigned to the operating schedules of a combination of equipment with the shortest grace periods from among combinations of equipment in each of the multiple equipment groups.

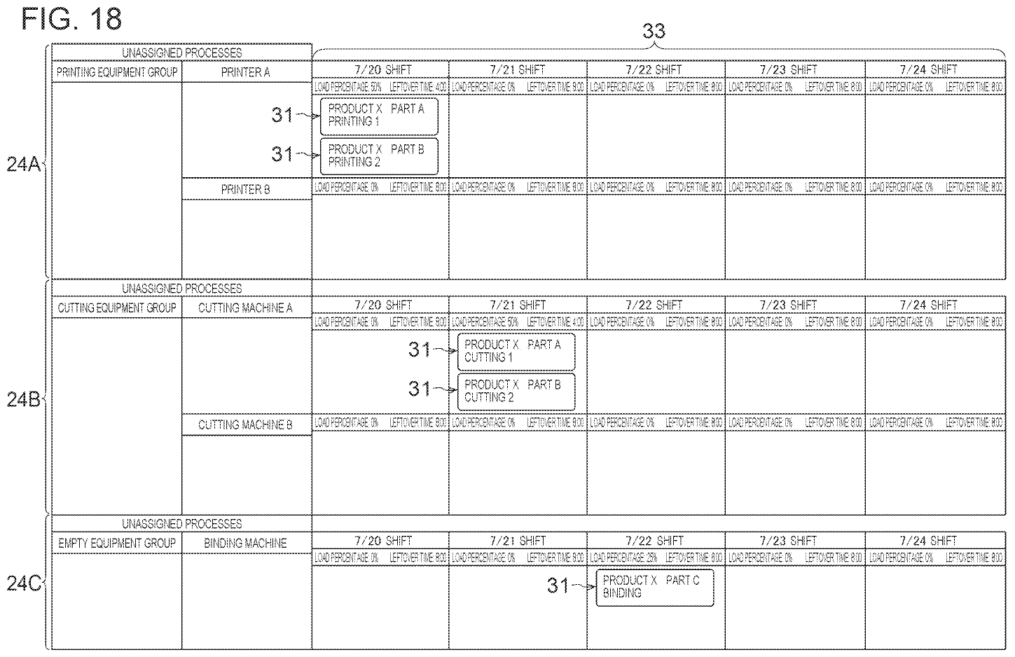

In the fourth specific example, from among combinations of the printers A and B in the printing equipment group and the cutting machines A and B in the cutting equipment group, the combination of the printer A and the cutting machine B is the combination with the shortest grace periods. Consequently, in the fourth specific example, as illustrated in FIG. 18, by assigning the printing processes 1 and 2 to the operating schedule of the printer A and assigning the cutting processes 1 and 2 to the operating schedule of the cutting machine B, each of multiple production processes may be assigned to the operating schedules of the combination with the shortest grace periods.

Note that in this case, the grace period until the next process involving the cutting machine B is set to 1 shift, and therefore the assignment start date for the binding process is 7/22, the date one day after 7/21 on which the cutting processes 1 and 2 are assigned.

As illustrated in FIG. 18, since there is an opening in the 7/22 shift of the binding machine, the processor 11 assigns the binding process to the 7/22 shift of the binding machine.

### Fifth Specific Example of Assignment Processing

In a fifth specific example, the starting date and time are set to a starting date and time going back a predetermined standard period from the shipping date and time of the product. In the fifth specific example, the standard period is set to the obtained by adding up the grace periods of equipment capable of executing the production processes to be assigned.

In the fifth specific example, for each piece of equipment, a grace period until the next process involving the equipment is set as follows, for example.
Printer A: 1 shift
Printer B: 2 shifts
Cutting machine A: 2 shifts
Cutting machine B: 1 shift
Binding machine: 1 shift

Furthermore, in the fifth specific example, the expected shipping date is set to 7/24. Note that in the fifth specific example, the other conditions are similar to the first specific example.

In the fifth specific example, if an instruction to execute assignment processing is given, the processor 11 first executes the process assignment processing for the printing processes 1 and 2, which are the first production process. In the fifth specific example, since the starting date and time are set to a starting date and time going back a predetermined standard period from the shipping date and time of the product, the assignment start date for the printing processes 1 and 2 are calculated as follows.

The period obtained by adding up the grace period of the printer A or the printer B, the grace period of the cutting machine A or the cutting machine B, and the grace period of the binding machine is set as the standard period. Specifically, for example, the period (4 shifts) obtained by adding up the grace period (1 shift) of the printer A, which is equipment with the highest priority in the printing equipment group, the grace period (2 shifts) of the cutting machine A, which is the equipment with the highest priority in the cutting equipment group, and the grace period (1 shift) of the binding machine is set as the standard period.

Thereafter, the starting date and time (7/20) going back the standard period (4 shifts) from the shipping date and time (7/24) is set as the assignment start date for the printing processes 1 and 2.

In the fifth specific example, as illustrated in FIG. 16, since there is an opening in the 7/20 shift of the printer A, which is the equipment with the highest priority in the printing equipment group, the processor 11 assigns the printing process 1 to the 7/20 shift of the printer A. Furthermore, since there is an opening in the 7/20 shift of the printer A, which is the equipment with the highest priority in the printing equipment group, the processor 11 assigns the printing process 2 to the 7/20 shift of the printer A.

Next, the processor 11 executes the process assignment processing for the cutting processes 1 and 2, which are the next production process after the printing processes 1 and 2. In the fourth specific example, the grace period until the next process involving the printer A is set to 1 shift, and therefore the assignment start date for the cutting process is 7/21, the date one day after 7/20 on which the printing processes 1 and 2 are assigned.

As illustrated in FIG. 16, since there is an opening in the 7/21 shift of the cutting machine A, which is the equipment with the highest priority in the cutting equipment group, the processor 11 assigns the cutting process 1 to the 7/21 shift of the cutting machine A. Furthermore, since there is an opening in the 7/21 shift of the cutting machine A, which is the equipment with the highest priority in the cutting equipment group, the processor 11 assigns the cutting process 2 to the 7/21 shift of the cutting machine A.

Next, the processor 11 executes the process assignment processing for the binding process, which is the next production process after the cutting processes 1 and 2. In the fourth specific example, the grace period until the next process involving the cutting machine A is set to 2 shifts, and therefore the assignment start date for the binding process is 7/22, the date two days after 7/21 on which the cutting processes 1 and 2 are assigned.

As illustrated in FIG. 16, since there is an opening in the 7/23 shift of the binding machine, the processor 11 assigns the binding process to the 7/23 shift of the binding machine.

As above, in the fifth specific example, the processor 11 is capable of setting the starting point for assigning production processes to a starting date and time going back a predetermined standard period from the shipping date and time of the product.

Also, in the fifth specific example, the processor 11 sets, as the standard period, the period obtained by adding up the grace periods of equipment capable of executing the production processes to be assigned.

Note that, as described above, the period (4 shifts) obtained by adding up the grace period (1 shift) of the printer A, which is equipment with the highest priority in the printing equipment group, the grace period (2 shifts) of the cutting machine A, which is the equipment with the highest priority in the cutting equipment group, and the grace period (1 shift) of the binding machine is set as the standard period, but the standard period is not limited thereto. For example, from among combinations of the grace period of the printer A or the printer B, the grace period of the cutting machine A or the cutting machine B, and the grace period of the binding machine, the period with the shortest grace periods may be set as the standard period, or the period with the longest grace periods may be set as the standard period.

### Exemplary Modifications

In the exemplary embodiment, if each of multiple production processes is associated with each of an equipment group and a single piece of equipment, the processor 11 assigns, on the basis of a predetermined condition, the production process associated with the single piece of equipment to the operating schedule of that piece of equipment, and then assigns, on the basis of a predetermined condition, the production process associated with the equipment group to the operating schedule of one of the multiple pieces of equipment, but the configuration is not limited to. For example, if each of multiple production processes is associated with each of an equipment group and a single piece of equipment, the processor 11 may be configured to assign, on the basis of a predetermined condition, the production process associated with the equipment group to the operating schedule of one of the multiple pieces of equipment, and then assign, on the basis of a predetermined condition, the production process associated with the single piece of equipment to the operating schedule of that piece of equipment.

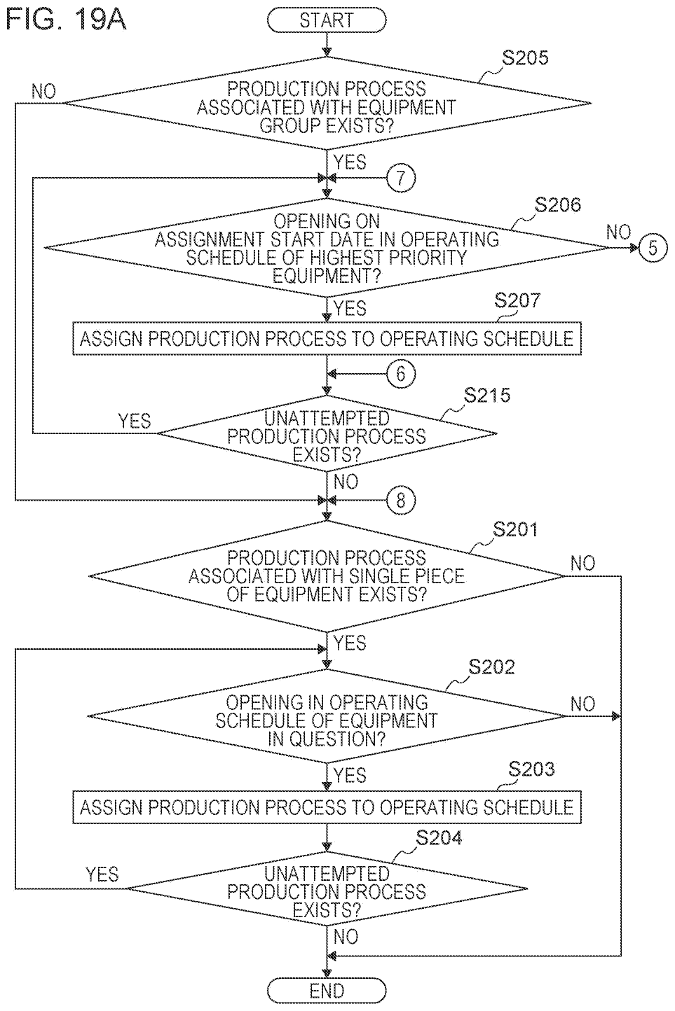

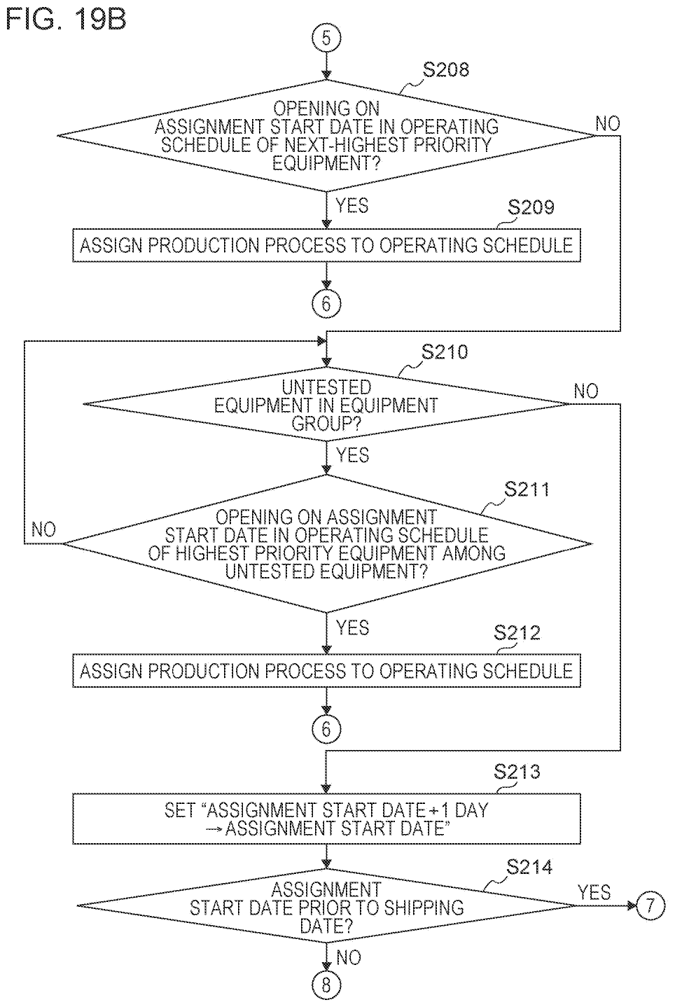

Specifically, for example, as illustrated in FIGS. 19A and 19B, in the process assignment processing, step S205 is executed prior to steps S201 to S204.

Furthermore, the processor 11 proceeds to step S201 in the case of determining in step S205 that a production process associated with an equipment group does not exist (step S205: NO), in the case of determining in step S214 that the assignment start date is later than the shipping date (step S214: NO), and in the case of determining in step S215 that there is no production process for which the process assignment processing has not been attempted (step S215: NO).

In the exemplary embodiment, the processor 11 is capable of associating a production process with one of either an equipment group or a single piece of equipment, but is not limited thereto. For example, the processor 11 may also be configured to associate a production process with only an equipment group.

In the exemplary embodiment, if there is an opening in the operating schedule of the equipment with the highest priority, the processor 11 assigns the production process to that operating schedule, but is not limited thereto. For example, the processor 11 may also be configured to assign a production process associated with an equipment group to any of multiple pieces of equipment on the basis of a condition which does not depend on priority and which is set in advance for the multiple pieces of equipment.

Also, if there is no opening in the operating schedule of the equipment with the highest priority, but there is an opening in the operating schedule of the equipment with the next-highest priority, the processor 11 assigns the production process to that operating schedule, but is not limited thereto. For example, the processor 11 may also be configured to assign the production process only to the operating schedule of the equipment with the highest priority.

In the exemplary embodiment, the processor 11 is capable of setting a grace period for each piece of equipment, including equipment belonging to an equipment group, but is not limited thereto. For example, the processor 11 may also be configured to set a blanket grace period for multiple pieces of equipment (for each equipment group, for example).

In the exemplary embodiment, the processor 11 is capable of setting the starting point for assigning production processes to a starting date and time going back a predetermined standard period from the shipping date and time of the product, but is not limited thereto. For example, the processor 11 may also be configured to set the starting point for assigning production processes only to the current date and time or to the expected print-ready date and time.

The present disclosure is not limited to the exemplary embodiment above, and various modifications, alterations, and improvements are possible without deviating from the gist of the present disclosure. For example, the exemplary modifications described above may also be plurally combined, as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### <Appendix>

(((1)))

An information processing apparatus comprising:
a processor configured to:
   associate a production process for producing a product with an equipment grouping that includes a plurality of equipment capable of executing the production process; and
   assign, if the production process is associated with the equipment grouping, the production process to an operating schedule of one of the plurality of equipment on a basis of a predetermined condition.

(((2)))

The information processing apparatus according to (((1))), wherein the processor is configured to:
associate the production process with one of either the equipment grouping or a single piece of equipment;
assign, if the production process is associated with the equipment grouping, the production process to an operating schedule of one of the plurality of equipment on a basis of a predetermined condition; and assign, if the production process is associated with the single piece of equipment, the production process to an operating schedule of the equipment on a basis of a predetermined condition.

(((3)))

The information processing apparatus according to (((2))), wherein:
if each of a plurality of production processes is associated with each of the equipment grouping and the single piece of equipment,
the processor is configured to:
   assign the production process associated with the single piece of equipment to an operating schedule of the equipment on a basis of a predetermined condition; and
   assign the production process associated with the equipment grouping to an operating schedule of one of the plurality of equipment on a basis of a predetermined condition.

(((4)))

The information processing apparatus according to (((2))), wherein:
if each of a plurality of production processes is associated with each of the equipment grouping and the single piece of equipment,
the processor is configured to:
   assign the production process associated with the equipment grouping to an operating schedule of one of the plurality of equipment on a basis of a predetermined condition, and thereafter;
   assign the production process associated with the single piece of equipment to an operating schedule of the equipment on a basis of a predetermined condition.

(((5)))

The information processing apparatus according to any one of (((1))) to (((4))), wherein:
the predetermined condition is a priority of the plurality of equipment, and
if there is an opening in the operating schedule of the equipment with the highest priority, the processor is configured to assign the production process to that operating schedule.

(((6)))

The information processing apparatus according to (((5))), wherein:
if there is no opening in the operating schedule of the equipment with the highest priority, but there is an opening in the operating schedule of the equipment with the next-highest priority,
the processor is configured to assign the production process to that operating schedule.

(((7)))

The information processing apparatus according to any one of (((1))) to (((6))), wherein the processor is configured to:
set a grace period for each piece of equipment included in the equipment grouping; and
assign, if a given production process is assigned to an operating schedule of equipment for which a grace period is set, a next production process after the given production process to an operating schedule of the equipment so as to leave the grace period open.

(((8)))

The information processing apparatus according to (((7))), wherein:
if a first production process and a second production process are assigned as the production process to an operating schedule of equipment for which the grace period is set,
the processor is configured to assign a third production process to be executed next after the first and second production processes to the operating schedule of the equipment on or after a latest endpoint from among endpoints of the grace periods of the equipment to which each of the first and second production processes is assigned.

(((9)))

The information processing apparatus according to (((7))), wherein:
if each of a plurality of production processes is associated with each of a plurality of equipment groupings,
the processor is configured to assign each of the plurality of production processes to the operating schedules of a combination of equipment with the shortest grace periods from among combinations of equipment in each of the plurality of equipment groupings.

(((10)))

The information processing apparatus according to any one of (((1))) to (((9))), wherein the processor is configured to:
set a starting point for assigning the production process to a starting date and time going back a predetermined standard period from a shipping date and time of the product; and
assign, if the starting point is set and the production process is associated with the equipment grouping, the production process to an operating schedule of one of the plurality of equipment, using the starting date and time as the starting point.

(((11)))

The information processing apparatus according to (((10))), wherein the processor is configured to:
set a grace period for each piece of equipment included in the equipment grouping; and
set, as the standard period, a period obtained by adding the grace period of equipment capable of executing the production process to be assigned.

(((12)))

The information processing apparatus according to any one of (((1))) to (((11))), wherein the processor is configured to:
set a grace period from a starting date and time that serves as a starting point of assigning the production process to a first production process; and
assign, if the grace period is set, the first production process to an operating schedule of the equipment so as to leave the grace period open.

(((13)))

An information processing program causing a computer to execute a process comprising:
assigning, if a production process for producing a product is associated with an equipment grouping that includes a plurality of equipment capable of executing the production process, the production process to an operating schedule of one of the plurality of equipment on a basis of a predetermined condition.

What is claimed is:

1. An information processing apparatus comprising:
a processor configured to:
associate a production process for producing a product with an equipment grouping that includes a plurality of equipment capable of executing the production process; and
assign, if the production process is associated with the equipment grouping, the production process to an operating schedule of one of the plurality of equipment on a basis of a predetermined condition.

2. The information processing apparatus according to claim 1, wherein the processor is configured to:
associate the production process with one of either the equipment grouping or a single piece of equipment;
assign, if the production process is associated with the equipment grouping, the production process to an operating schedule of one of the plurality of equipment on a basis of a predetermined condition; and
assign, if the production process is associated with the single piece of equipment, the production process to an operating schedule of the equipment on a basis of a predetermined condition.

3. The information processing apparatus according to claim 2, wherein:
if each of a plurality of production processes is associated with each of the equipment grouping and the single piece of equipment,
the processor is configured to:
assign the production process associated with the single piece of equipment to an operating schedule of the equipment on a basis of a predetermined condition; and
assign the production process associated with the equipment grouping to an operating schedule of one of the plurality of equipment on a basis of a predetermined condition.

4. The information processing apparatus according to claim 2, wherein:
if each of a plurality of production processes is associated with each of the equipment grouping and the single piece of equipment,
the processor is configured to:
assign the production process associated with the equipment grouping to an operating schedule of one of the plurality of equipment on a basis of a predetermined condition, and thereafter;
assign the production process associated with the single piece of equipment to an operating schedule of the equipment on a basis of a predetermined condition.

5. The information processing apparatus according to claim 1, wherein:
the predetermined condition is a priority of the plurality of equipment, and
if there is an opening in the operating schedule of the equipment with the highest priority, the processor is configured to assign the production process to that operating schedule.

6. The information processing apparatus according to claim 5, wherein:
if there is no opening in the operating schedule of the equipment with the highest priority, but there is an opening in the operating schedule of the equipment with the next-highest priority,
the processor is configured to assign the production process to that operating schedule.

7. The information processing apparatus according to claim 1, wherein the processor is configured to:
set a grace period for each piece of equipment included in the equipment grouping; and
assign, if a given production process is assigned to an operating schedule of equipment for which a grace period is set, a next production process after the given production process to an operating schedule of the equipment so as to leave the grace period open.

8. The information processing apparatus according to claim 7, wherein:
if a first production process and a second production process are assigned as the production process to an operating schedule of equipment for which the grace period is set,
the processor is configured to assign a third production process to be executed next after the first and second production processes to the operating schedule of the equipment on or after a latest endpoint from among endpoints of the grace periods of the equipment to which each of the first and second production processes is assigned.

9. The information processing apparatus according to claim 7, wherein:
if each of a plurality of production processes is associated with each of a plurality of equipment groupings,
the processor is configured to assign each of the plurality of production processes to the operating schedules of a combination of equipment with the shortest grace periods from among combinations of equipment in each of the plurality of equipment groupings.

10. The information processing apparatus according to claim 1, wherein the processor is configured to:
set a starting point for assigning the production process to a starting date and time going back a predetermined standard period from a shipping date and time of the product; and
assign, if the starting point is set and the production process is associated with the equipment grouping, the production process to an operating schedule of one of the plurality of equipment, using the starting date and time as the starting point.

11. The information processing apparatus according to claim 10, wherein the processor is configured to:
set a grace period for each piece of equipment included in the equipment grouping; and
set, as the standard period, a period obtained by adding the grace period of equipment capable of executing the production process to be assigned.

12. The information processing apparatus according to claim 1, wherein the processor is configured to:
set a grace period from a starting date and time that serves as a starting point of assigning the production process to a first production process; and
assign, if the grace period is set, the first production process to an operating schedule of the equipment so as to leave the grace period open.

13. A non-transitory computer readable medium storing a program causing a computer to execute a process comprising:
assigning, if a production process for producing a product is associated with an equipment grouping that includes a plurality of equipment capable of executing the production process, the production process to an operating schedule of one of the plurality of equipment on a basis of a predetermined condition.

14. An information processing apparatus comprising:
associating means for associating a production process for producing a product with an equipment grouping that includes a plurality of equipment capable of executing the production process; and
assigning means for assigning, if the production process is associated with the equipment grouping, the production process to an operating schedule of one of the plurality of equipment on a basis of a predetermined condition.
